(19) United States
(12) Patent Application Publication
(10) Pub. No.: US 2026/0127105 A1
(43) Pub. Date: May 7, 2026

(54) SYSTEMS AND METHODS FOR VALIDATING ACTION GRAPHS USING MULTI-AUTONOMOUS MODEL ARCHITECTURES ACROSS COMPUTER NETWORKS

(71) Applicant: Capital One Services, LLC, McLean, VA (US)

(72) Inventors: Shixiong ZHANG, Redmond, WA (US); Sambit SAHU, Hopewell Junction, NY (US); Anirban DAS, San Mateo, CA (US); Kartik BALASUBRAMANIAM, Framingham, MA (US); Vivek NAYAK, San Francisco, CA (US); Milind NAPHADE, Cupertino, CA (US); Premkumar NATARAJAN, Rolling Hills Estates, CA (US)

(73) Assignee: Capital One Services, LLC, McLean, VA (US)

(21) Appl. No.: 19/080,667

(22) Filed: Mar. 14, 2025

Related U.S. Application Data
(60) Provisional application No. 63/717,232, filed on Nov. 6, 2024.

(51) Int. Cl. G06F 11/3698; G06F 8/65; G06F 21/53

(52) U.S. Cl. CPC G06F 11/3698; G06F 8/65; G06F 21/53

(57) ABSTRACT

Systems and methods for a multi-autonomous model architecture. For example, an autonomous model operates independently, within the architecture to perform tasks on behalf of itself or another system. These models possess the ability to make decisions and act without intervention, based on their programming and the information they perceive from their environment, thereby increasing autonomy, adaptability, and/or perception. More specifically, the system uses a multi-autonomous model architecture that comprises an understanding model (e.g., tasked with generating a contextual representation of inputted information), a planning model (e.g., tasked with generating an action graph for generating a complex solution), and an evaluation model (e.g., tasked with independently validating the action graph prior to recommending to a user).

### CROSS-REFERENCE TO RELATED APPLICATION(S)

This application claims the benefit of priority of U.S. Provisional Patent Application No. 63/717,232 , filed Nov. 6, 2024. The content of the foregoing application is incorporated herein in its entirety by reference.

### BACKGROUND

Chatbots are typically implemented using a combination of natural language processing (NLP), machine learning, and sometimes rule-based systems. The implementation begins with defining the chatbot's purpose and the scope of interactions it will handle. NLP techniques are used to understand and interpret user inputs, converting the natural language into structured data that the chatbot can process. Machine learning models, particularly those involving deep learning, are trained on large datasets to improve the chatbot's ability to recognize patterns and provide relevant responses. These models enable the chatbot to understand context, manage dialogues, and learn from interactions over time. In some cases, rule-based systems are used to handle specific queries or follow predefined scripts, particularly for simpler or more structured interactions. The chatbot's architecture often includes integration with messaging platforms, databases, and APIs to access necessary information and provide dynamic responses. Additionally, developers focus on user experience design to ensure that the interactions are intuitive and engaging. Continuous monitoring and updating are crucial to maintain the chatbot's effectiveness and to adapt to new user needs or changes in language patterns.

Dealing with complex problems is technically challenging for chatbots due to several factors related to the intricacies of human language and cognition. Human language is highly context-dependent, nuanced, and often ambiguous, making it difficult for chatbots to accurately interpret and respond to complex queries. Understanding the context requires not just parsing words but also grasping the intent, sentiment, and sometimes even cultural or situational subtleties, which can be beyond the capabilities of many NLP models.

### SUMMARY

Further exacerbating these technical issues, complex problems often involve complex solutions, which may include multiple steps, dependencies, and/or a need for deep domain-specific knowledge. This requires chatbots to have advanced reasoning abilities, extensive and up-to-date knowledge bases, and/or the capacity to manage multi-turn conversations effectively. Maintaining coherence and relevance throughout an extended dialogue, while also handling interruptions or changes in topic, adds another layer of difficulty. The limitations of current artificial intelligence models struggle preparing these complex solutions even with contextual relevance.

For example, artificial intelligence, including, but not limited to, machine learning, deep learning, etc. (referred to collectively herein as artificial intelligence models, machine learning models, or simply models) refers to a wide-ranging branch of computer science concerned with building smart machines capable of performing tasks that typically require human intelligence. Key benefits of artificial intelligence are its ability to process data, find underlying patterns, and/or perform real-time determinations. However, despite these benefits and despite the wide-ranging number of potential applications, practical implementations of artificial intelligence have been hindered by several technical problems. First, artificial intelligence may rely on large amounts of high-quality data. The process for obtaining this data and ensuring it is high-quality can be complex and time-consuming. Second, any data that is obtained may need to be categorized and labeled accurately, which can be difficult, time-consuming and a manual task. Finally, results based on artificial intelligence can be difficult to review as the process by which the results are made may be unknown or obscured. This obscurity can create hurdles for identifying errors in the results, as well as improving the models providing the results. These technical problems may present an inherent problem with attempting to use an artificial intelligence-based solution in preparing complex solutions.

Systems and methods are described herein for novel uses and/or improvements to artificial intelligence applications in order to generate complex technical responses and solutions. As one example, systems and methods are described herein for a multi-autonomous model architecture. For example, an autonomous model operates independently, within the architecture to perform tasks on behalf of itself or another system. These models possess the ability to make decisions and act without intervention, based on their programming and the information they perceive from their environment, thereby increasing autonomy, adaptability, and/or perception. More specifically, the system uses a multi-autonomous model architecture that comprises an understanding model (e.g., tasked with generating a contextual representation of inputted information), a planning model (e.g., tasked with generating an action graph for generating a complex solution), and an evaluation model (e.g., tasked with independently validating the action graph prior to recommending to a user).

Notably, this architecture is uniquely positioned to understand complex inquiries and generate complex responses. For example, as the first autonomous model is used for generating contextual representations of inputted information, this autonomous model may be trained separately on existing training data. This autonomous model may use existing large language models (LLMs) to determine contextual information for a given input. The second autonomous model may also be trained independently to generate actions graphs for various complex solutions. In particular, this model may use information about a given knowledge base and/or objective type that may be kept separate from the first autonomous model (thus reducing the training burden). Finally, the third autonomous model may also be trained to generate validation sandboxes that may test action graphs generated by the second autonomous model in order to determine whether an action graph will be successful without having to effect actual data.

For example, training a model to generate action graphs for various complex solutions is challenging due to several factors. First, the inherent complexity and variability of real-world environments make it difficult to create a comprehensive dataset that captures all possible states and actions. This complexity requires the model to generalize from limited data, often leading to issues with accuracy and robustness. Second, generating action graphs involves understanding and predicting the outcomes of a wide range of actions in dynamic and often unpredictable environments. This necessitates sophisticated modeling of cause-and-effect relationships, which can be computationally intensive and prone to errors. Another significant challenge is the need for the model to handle long-term dependencies and multi-step planning. In complex scenarios, actions taken early in the sequence can have far-reaching consequences, requiring the model to maintain a detailed understanding of the evolving state over time. This temporal aspect increases the difficulty of training, as the model must learn to balance short-term rewards with long-term objectives. Additionally, the model may need explore a vast action space to learn effective strategies, but excessive exploration can lead to inefficiencies and increased training times. The stochastic nature of many environments adds another layer of difficulty. Randomness and uncertainty in outcomes necessitate the model to develop robust strategies that can adapt to varying conditions. This requires advanced probabilistic reasoning and the ability to anticipate and mitigate the impact of unexpected events. Finally, ensuring that the generated action graphs are interpretable and align with human understanding and decision-making processes is crucial, adding an additional constraint to the model training.

In view of these challenges, the system uses the third autonomous model to generate sandbox validations for the action graphs developed by the second autonomous model. For example, sandbox validation helps mitigate the difficulty in training the model to generate action graphs for various complex solutions by providing a controlled, simulated environment where the model can be tested and refined before deployment in real-world scenarios. For example, the sandbox allows for the creation of a controlled environment where variables can be managed, and specific scenarios can be replicated consistently. This controlled setting makes it easier to identify and correct errors, ensuring that the model performs reliably under known conditions. Additionally, by testing the action graphs in a sandbox, developers can observe how it behaves in complex situations without the risk of negative consequences in the real world. This is particularly important for high-stakes applications where errors could lead to significant harm or loss. Sandbox validation also supports an iterative process of testing and refinement. Developers can run multiple simulations, observe the outcomes, and adjust the model as needed. This iterative cycle helps to progressively improve the model's accuracy and robustness in generating action graphs. In a sandbox, a wide range of scenarios, including long-term scenario, edge cases, and/or rare events, can be simulated. This helps the model learn to handle complexity and variability, improving its generalization capabilities when exposed to real-world conditions.

Moreover, as the third autonomous model may be used to validate action graphs, the validated action graphs and their associated modification if any, may be implemented directly as code script. As these changes are already compartmentalized based on the autonomous model, the system may enter these graph characteristics and/or modifications directly into the first autonomous model to generate responses describing each individual portion of the action graph. By doing so, the first autonomous model does not require additional training to ensure a contextual understanding of the long-term scenario, edge cases, and/or rare events that may have been accounted for; thus, further reducing the training time involved in the multi-autonomous model architecture.

Finally, the autonomous models may process code representing the action graphs. For example, as the action graph is represented by the code, the system can use code analysis techniques on the action graphs to determine the variables, computations, and/or functions that are being performed. By doing so, the system may learn more efficiently as natural language typically has some ambiguity, whereas code is very precise. Additionally, the code is typically more limited in the way it is written, the functions that it performs, and the constraints in general.

In some aspects, systems and methods for generating complex responses to user interface queries using a multi-autonomous model architecture are described. For example, the system may receive, at a user interface, a first user query. The system may process the first user query with a first autonomous model of a multi-autonomous model architecture, to generate a first action graph objective, wherein the first autonomous model is trained using a first large language model to determine contextual information in order to determine action graph objective outputs for inputted user queries. The system may process the first action graph objective with a second autonomous model to generate a first action graph, wherein the second autonomous model is trained using a second large language model to determine action graph outputs for inputted action graph objectives. The system may process the first action graph with a third autonomous model to generate a first validated action graph, wherein the third autonomous model is trained using a third large language model to validate inputted action graphs. The system may generate for display, in the user interface, a first response to the first user query based on the first validated action graph.

In some aspects, systems and methods for validating action graphs using multi-autonomous model architectures are described. For example, the system may receive, at a user interface, a first user query from a first user, wherein the first user query indicates an initial state and a requested final state. The system may, in response to the first user query, generate with an autonomous planner model, of a multi-autonomous model architecture, a first action graph, wherein the first action graph comprises a plurality of nodes and a plurality of edges from the initial state and the requested final state. The system may process the first action graph with an autonomous evaluation model to generate a first validated action graph by: generating a sandbox session for the first action graph; retrieving a user profile for the user; populating the sandbox session with the user profile data from the user profile; and testing the first action graph in the sandbox session to determine whether the first action graph results in the requested final state. The system may generate for display, in the user interface, a first response to the first user query based on the first validated action graph.

In some aspects, systems and methods for updating code script in validated action graphs using multi-autonomous model architectures are described. For example, the system may receive, at a user interface, a first user query, wherein the first user query indicates an initial state and a requested final state. The system may, in response to the first user query, generate with an autonomous planner model, of a multi-autonomous model architecture, a first action graph, wherein the first action graph comprises a plurality of nodes and a plurality of edges from the initial state and the requested final state, and wherein the plurality of nodes and the plurality of edges from the initial state and the requested final state are represented by first code script. The system may process the first action graph with an autonomous evaluation model to generate a first validated action graph by: determining a first update to the first action graph required to generate the first validated action graph; processing the first update using a large language model to generate a second code script corresponding to the first update; and updating the first code script with the second code script. The system may generate for display, in the user interface, a first response to the first user query based on the first validated action graph.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for generating complex technical responses using a multi-autonomous model architecture.

FIGS. 2A-2D shows an illustrative diagram for an evaluator model, in accordance with one or more embodiments.

FIG. 3 shows illustrative components for a system used to multi-autonomous model architecture, in accordance with one or more embodiments.

FIG. 4 shows a flowchart of the steps involved in using multi-autonomous model architectures, in accordance with one or more embodiments.

FIG. 5 shows a flowchart of the steps involved in validating action graphs using multi-autonomous model architectures, in accordance with one or more embodiments.

FIG. 6 shows a flowchart of the steps involved in updating code script in validated action graphs using multi-autonomous model architectures, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

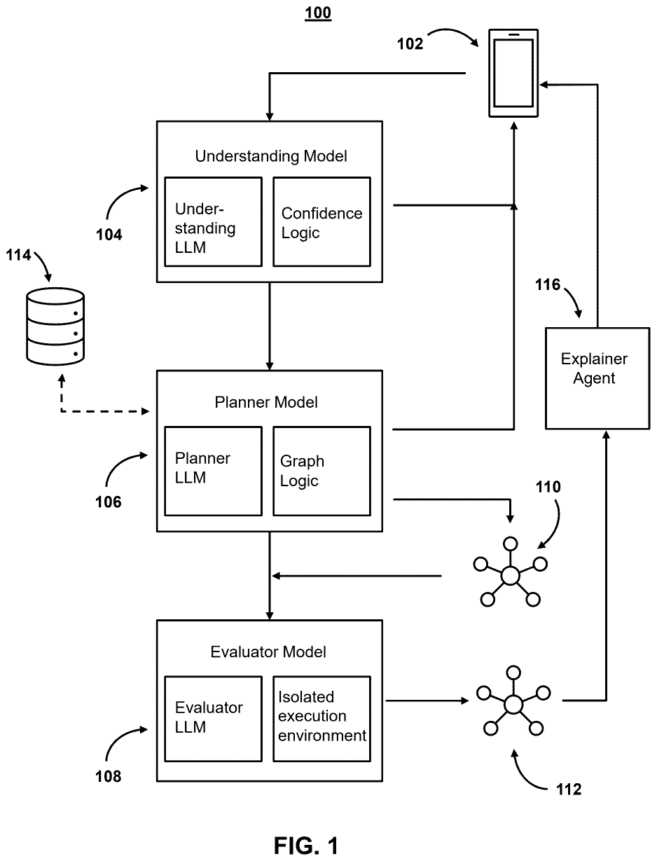

FIG. 1 shows an illustrative diagram for generating complex technical responses using a multi-autonomous model architecture, in accordance with one or more embodiments. For example, systems and methods are described herein for novel uses and/or improvements to artificial intelligence applications in order to generate complex technical responses and solutions. For example, system 100 may receive and/or provide responses to a user and/or other system via user interface 102. As referred to herein, a “user interface” may comprise a human-computer interaction and communication in a device, and may include display screens, keyboards, a mouse, and the appearance of a desktop. For example, a user interface may comprise a way a user interacts with an application or a website.

As referred to herein, “content” should be understood to mean an electronically consumable user asset, such as Internet content (e.g., streaming content, downloadable content, Webcasts, etc.), video clips, audio, content information, pictures, rotating images, documents, playlists, websites, articles, books, electronic books, blogs, advertisements, chat sessions, social media content, applications, games, and/or any other media or multimedia and/or combination of the same. Content may be recorded, played, displayed, or accessed by user devices, but can also be part of a live performance. Furthermore, user generated content may include content created and/or consumed by a user. For example, user generated content may include content created by another, but consumed and/or published by the user.

The system may monitor content generated by the user to generate user profile data. As referred to herein, “a user profile” and/or “user profile data” may comprise data actively and/or passively collected about a user. For example, the user profile data may comprise content generated by the user and a user characteristic for the user. A user profile may be content consumed and/or created by a user.

User profile data may also include a user characteristic. As referred to herein, “a user characteristic” may include about a user and/or information included in a directory of stored user settings, preferences, and information for the user. For example, a user profile may have the settings for the user's installed programs and operating system. In some embodiments, the user profile may be a visual display of personal data associated with a specific user, or a customized desktop environment. In some embodiments, the user profile may be digital representation of a person's identity. The data in the user profile may be generated based on the system actively or passively monitoring.

In some embodiments, a user profile may be for a customer at a bank, credit card company, or other financial institution and may comprise a comprehensive digital representation of the individual's personal, financial, and/or behavioral information. This profile may include basic demographic details such as name, age, address, and contact information, as well as more specific data like employment status, income, and financial goals. Financial information encompasses account balances, transaction history, credit scores, and loan details. The profile also tracks behavioral data, including spending habits, saving patterns, and investment preferences. Additionally, it may contain information about the user's interactions with the institution, such as customer service interactions, feedback, and preferences for communication channels.

This detailed aggregation of data enables the financial institution to offer personalized services and products tailored to the user's needs and preferences. For example, it allows banks to recommend specific savings accounts, credit card companies to offer customized credit limits or rewards programs, and investment firms to suggest suitable investment portfolios. The user profile also plays a crucial role in risk assessment and fraud detection, helping institutions to identify unusual activities that deviate from the user's typical behavior. Moreover, it facilitates compliance with regulatory requirements by ensuring that all necessary personal and financial information is accurately recorded and regularly updated. By leveraging the comprehensive insights provided by user profiles, financial institutions can enhance customer satisfaction through more personalized and relevant service offerings, improve operational efficiency, and strengthen security measures.

As one example, systems and methods are described herein for a multi-autonomous model architecture. For example, an autonomous model operates independently, within the architecture to perform tasks on behalf of itself or another system. In some embodiments, a multi-autonomous model architecture for an artificial intelligence system involves the integration of multiple autonomous models, each designed to perform specific tasks independently while collaborating to achieve a larger, overarching goal. In this architecture, each autonomous model operates with a degree of independence, equipped with its own set of algorithms, learning mechanisms, and decision-making processes tailored to its designated function. These models can include a variety of specialized artificial intelligence components, such as natural language processors, image recognizers, recommendation engines, and predictive analytics modules. Each autonomous model may process its inputs and makes decisions based on its own expertise, then shares relevant information with other autonomous models to collectively refine their actions and strategies. For instance, in an e-commerce platform, one autonomous model might handle user interaction and query understanding, another might focus on personalizing product recommendations based on user behavior, while a third might optimize the logistics and delivery processes. This architecture enables the system to handle complex and multifaceted problems more efficiently by leveraging the strengths of each specialized model. It promotes scalability, as new autonomous agents can be added to the system to address emerging needs or enhance existing capabilities. Additionally, it enhances robustness, as the failure or underperformance of one agent does not necessarily cripple the entire system; other agents can adapt and compensate.

In some embodiments, the multi-autonomous model architecture comprises a plurality of autonomous models, and wherein processing inputs by the multi-autonomous model architecture comprises receiving one or more outputs from one or more of the plurality of autonomous models and autonomously inputting the one or more outputs into the one or more of the plurality of autonomous models. In this architecture, each autonomous model is designed to handle particular types of inputs and generate corresponding outputs based on its specialized functions. The defining feature of this architecture is its ability to process inputs by seamlessly integrating the outputs from multiple autonomous models.

When processing inputs, the multi-autonomous model architecture begins by receiving one or more outputs from one or more of its autonomous models. These initial outputs are the results of independent computations or decisions made by the respective models based on their designated tasks. The architecture then autonomously inputs these outputs into one or more other autonomous models within the system. This inter-model communication and data transfer are performed without the need for external intervention, allowing the system to dynamically and continuously refine its operations.

By leveraging the outputs of various models as inputs for others, the multi-autonomous model architecture can achieve complex, multi-step processing and decision-making. This interconnected approach enables the system to handle intricate tasks that require the combined expertise of different models, thereby enhancing the overall efficiency and effectiveness of the processing workflow. The autonomous nature of the models ensures that the system can adapt and respond to varying inputs and conditions, providing a robust and scalable solution for advanced computational and analytical applications.

Moreover, a multi-autonomous model architecture facilitates continuous learning and improvement. Each autonomous agent can independently update its algorithms and improve its performance based on new data and interactions, contributing to the overall evolution of the system. This decentralized approach to learning and adaptation allows for more rapid and flexible responses to changes in the environment or user demands, making the system more resilient and effective in dynamic and complex scenarios.

These models possess the ability to make decisions and act without intervention, based on their programming and the information they perceive from their environment, thereby increasing autonomy, adaptability, and/or perception. More specifically, the system uses a multi-autonomous model architecture that comprises an understanding model (e.g., tasked with generating a contextual representation of inputted information), a planning model (e.g., tasked with generating an action graph for generating a complex solution), and an evaluation model (e.g., tasked with independently validating the action graph prior to recommending to a user).

As shown in FIG. 1, system 100 may include numerous autonomous models. For example, system 100 includes autonomous model 104, which is used for generating contextual representations of inputted information, this autonomous model may be trained separately on existing training data. This autonomous model may use existing large language models (LLMs) to determine contextual information for a given input.

System 100 may be used to process, using one or more autonomous models, a first user query to generate a first action graph objective using a first large language model to determine contextual information in order to determine action graph objective outputs for inputted user queries, wherein the first action graph objective is processed to generate a first action graph, and wherein the first action graph is processed to generate a first validated action graph. System 100 may then generate a first response to the first user query based on the first validated action graph.

In system 100, processing a first user query involves multiple autonomous models and steps to generate a structured, validated response that aligns with the user's intent. When a first user query is received, the system initiates processing by using one or more autonomous models that break down the query to derive a clear objective, referred to as the first action graph objective. A first LLM may be employed at this stage to analyze the context of the query, which includes interpreting nuances, relevant past interactions, and any domain-specific information that informs the objective. This contextual understanding allows the system to frame the first action graph objective accurately, which serves as the foundation for constructing the initial action graph. This action graph essentially maps out the sequence of steps or processes needed to achieve the identified objective, organizing potential actions and dependencies in a structured manner.

Once the first action graph is generated, it undergoes a validation process to produce a first validated action graph. During this validation, system 100 applies various checks, including rule-based and model-based evaluations, to ensure that each action within the graph is logical, compliant with system policies, and feasible based on the system's resources and constraints. This validated action graph represents a refined version of the initial plan, now optimized for accuracy and alignment with system objectives.

To generate a first response to the user query, system 100 utilizes the validated action graph, which now encapsulates a reliable plan of action based on the query's context and requirements. By following the validated steps within the action graph, the system can generate a response that is both relevant and precise, drawing directly from the validated action paths and ensuring that each element of the response aligns with the user's initial intent. This layered approach allows system 100 to provide a robust, contextually informed response to the first user query.

In some embodiments, system 100 may begin with a selection of a suitable LLM, such as GPT-4, which has been pre-trained on vast amounts of text data and can understand and generate human-like language. Autonomous model 104 may be designed to interface with the LLM, leveraging its language understanding capabilities to enhance its decision-making processes. The integration process may start by defining the types of contextual information the autonomous model needs for its tasks. This may include identifying the relevant domains, specific queries, and the kind of contextual insights required. Autonomous model 104 may be equipped with mechanisms to preprocess input data and format queries in a way that the LLM can understand. This involves natural language processing (NLP) techniques such as tokenization, normalization, and embedding.

Once the input is prepared, autonomous model 104 may send queries to the LLM, requesting contextual information. The LLM processes these queries using its vast knowledge base and generates responses that provide the needed context. The system must then interpret these responses correctly, which may involve additional NLP techniques to parse and extract relevant information from the LLM's output.

To effectively train autonomous model 104, supervised learning techniques may be employed. The model may be trained on a dataset comprising input scenarios, corresponding queries to the LLM, and the desired contextual outputs. During training, the model learns to optimize its queries and improve its understanding of the LLM's responses. Reinforcement learning can also be utilized, where the model receives feedback on the usefulness of the contextual information provided by the LLM and adjusts its querying strategy accordingly. In some embodiments, the training process includes iterative refinement. Autonomous model 104 may be tested in various scenarios, and its performance is evaluated based on how well it uses the contextual information to make decisions. Any gaps in understanding or misinterpretations may be addressed by updating the model's querying and processing techniques. Additionally, fine-tuning the LLM on domain-specific data can improve the relevance and accuracy of the contextual information provided. Advanced techniques such as attention mechanisms and context windows may be incorporated to ensure that the autonomous model can handle long-term dependencies and maintain coherence in its queries and decision-making. These techniques help the model focus on the most relevant parts of the LLM's responses, improving the quality of the contextual information it utilizes.

In some embodiments, continuous monitoring and updating may be performed. For example, autonomous model 104 and/or its LLM may be regularly updated with new data and insights to ensure they remain effective in dynamic environments. Additionally, autonomous model 104 may query user interface 102 if there is missing data, a user query requires more information, and/or a clarification is needed.

System 100 includes autonomous model 106, which may also be trained independently to generate actions graphs (e.g., action graph 110) for various complex solutions. In particular, this model may use information about a given knowledge base and/or objective type that may be kept separate from the first autonomous model (thus reducing the training burden).

As described herein, an action graph may be a visual or conceptual representation of the possible actions a model can take within a particular environment or system, and the subsequent states that result from these actions. It is a directed graph where nodes represent states or situations, and edges represent actions that transition from one state to another. Each node in the graph may represent a specific state or situation that the model can be in. These states can include any relevant information about the environment or the model itself. Edges represent the actions that the model can take to move from one state to another. Each edge is directed, indicating the flow from an initial state to a resulting state. The labels on the edges may describe the actions taken by the model. These actions could be physical movements, decisions, or any form of interaction with the environment. The process of moving from one node to another via an edge is called a state transition, which shows how the model's actions change the state of the system.

Action graph 110 may comprise a sequence of actions a model can take to achieve certain goals, solve problems, and/or navigate environments. For example, autonomous model 106 may be trained to generate action graphs that comprise the best sequence of actions to reach a desired goal state from a starting state. In another example, autonomous model 106 may be trained to generate action graphs that comprise that comprise plans or strategies by evaluating different possible sequences of actions and their outcomes. In another example, autonomous model 106 may be trained to generate action graphs that comprise models and/or simulations of the behavior of user profiles in various scenarios to predict outcomes and optimize performance. In another example, autonomous model 106 may be trained to generate action graphs that assist in decision-making processes by visualizing the consequences of different actions and selecting the most beneficial path.

In some embodiments, an action graph may comprise a plurality of nodes and a plurality of edges from the initial state and the requested final state. The action graph may be a directed graph structure that models the transitions between different states through a series of actions. It consists of a plurality of nodes, each representing a unique state within the system. Additionally, it includes a plurality of edges, where each edge signifies an action or event that causes a transition from one node (state) to another. The graph begins with an initial node representing the initial state of the system. Through a series of directed edges, it maps out the potential actions leading to subsequent states, ultimately culminating in one or more nodes that represent the requested final state(s).

In some embodiments, to generate an action graph, the system may determine a plurality of pathways through the plurality of nodes using the plurality of edges, wherein each of the plurality of pathways comprises a respective route from the initial state and the requested final state. The system may then determine, based on the first user query, first criterion. The system may compare the first criterion to a first route, wherein the first route corresponds to a first pathway of the plurality of pathways. The system may select the first pathway from the plurality of pathways based on comparing the first criterion to the first route. For example, the system generates an action graph by initially identifying all possible states and actions that can transition the system from the initial state to the requested final state. It does this by determining a plurality of pathways through the plurality of nodes, utilizing the plurality of edges that connect these nodes. Each pathway represents a unique sequence of actions or transitions leading from the initial state to the final state. Once these pathways are established, the system considers a first user query, which specifies a first criterion for evaluating these pathways. The system then compares this first criterion to a first route, which corresponds to one specific pathway among the multiple pathways. This comparison involves assessing how well the first route meets the specified criterion. Based on this comparison, the system selects the first pathway that best aligns with the first criterion from the plurality of pathways. This process ensures that the chosen pathway is optimal according to the user's specified criteria, thereby facilitating efficient and effective decision-making and planning within the system.

In some embodiments, the system determines a first pathway through the plurality of nodes using the plurality of edges, determines a second pathway through the plurality of nodes using the plurality of edges, determines a comparison criterion based on the first user query, and compares the first pathway to the second pathway based on the comparison criteria. For example, the system determines a first pathway through a plurality of nodes using a plurality of edges by initially identifying all possible transitions from the initial state, mapping out each potential subsequent state. This process continues recursively until a complete route from the initial state to the requested final state is established, forming the first pathway. Similarly, the system determines a second pathway by exploring an alternative set of transitions and states, again starting from the initial state and progressing to the final state through a different sequence of nodes and edges.

Once both the first and second pathways are established, the system then processes a first user query to determine a comparison criterion. This criterion may be derived from the user's requirements and could include factors such as cost, time, resource usage, or any other change in a value in a user profile and/or state characteristic. The system then evaluates both the first and second pathways based on this criterion, comparing how each pathway performs relative to the specified metric. By analyzing the pathways against the comparison criterion, the system identifies which pathway better meets the user's needs, facilitating an informed decision on the optimal route from the initial state to the final state. This process ensures that the chosen pathway aligns with the user's preferences and operational constraints, thereby optimizing the system's performance and effectiveness.

In some embodiments, the system may determine pairs of the plurality of nodes to connect using the plurality of edges and determine weights for the pairs based on the state characteristics. For example, the system determines pairs of nodes in an action graph to connect using edges by analyzing the potential transitions between states within the graph. The system may examine the characteristics of the action graph, which may include factors such as the type of actions available, the conditions required for each transition, and the overall structure of the graph. It then identifies which pairs of nodes (states) can be directly connected based on these characteristics.

To assign weights to these edges, the system may use action graph characters, user profile data, and/or state characterizes. For example, the user profile data, which might include user preferences, historical behavior, and specific needs or goals. This data helps the system understand which transitions might be more favorable or relevant to the user. Additionally, the system takes into account the characteristics of each state, such as the resources required to achieve a state, the time needed, or the potential benefits and drawbacks of transitioning to that state.

By integrating these elements, the system can determine appropriate weights for each pair of connected nodes. These weights reflect the relative desirability or cost of making a particular transition, incorporating both the inherent characteristics of the action graph and the personalized aspects derived from the user profile data and state characteristics. This comprehensive approach ensures that the edges in the action graph are weighted in a manner that aligns with both the system's operational parameters and the user's specific context and preferences.\

In some embodiments, the system may determine a number of the plurality of nodes based on the first user query and determine a number of edges to connect the plurality of nodes based on the first user query. For example, the system may determine the number of nodes in an action graph based on the first user query by analyzing the specific requirements and constraints outlined in the query. The user query might specify desired outcomes, intermediate states, and/or certain conditions that must be met. By interpreting these requirements, the system identifies the necessary states (nodes) that need to be represented within the action graph to fulfill the user's objectives. This involves understanding the scope of the problem, the various stages involved, and any distinct points of interest that need to be included.

Once the number of nodes is determined, the system proceeds to determine the number of edges required to connect these nodes, again guided by the specifics of the first user query. The edges represent the possible transitions or actions between states. The system evaluates the logical connections and interactions between the nodes, considering the actions that can realistically lead from one state to another. It also takes into account the criteria specified in the user query, such as efficiency, cost, or other operational metrics, to decide the most relevant and necessary transitions. In essence, the system constructs the action graph by first mapping out the necessary nodes that represent key states or stages as per the user query. It then connects these nodes with edges that signify feasible and relevant transitions, ensuring that the structure of the graph aligns with the user's specified goals and constraints. This process ensures that the action graph is both comprehensive and tailored to meet the user's specific needs.

The autonomous models may process code representing the action graphs. For example, as the action graph is represented by the code, the system can use code analysis techniques on the action graphs to determine the variables, computations, and/or functions that are being performed. By doing so, the system may learn more efficiently as natural language typically has some ambiguity, whereas code is very precise. Additionally, the code is typically more limited in the way it is written, the functions that it performs, and the constraints in general.

For example, an autonomous model processes code representing action graphs by first parsing the code to construct an abstract syntax tree (AST), which breaks down the code into its constituent parts, such as variables, computations, and functions. This AST serves as a hierarchical representation of the program's structure, allowing the system to analyze the relationships and dependencies between different components. Code analysis techniques, such as static analysis, are employed to examine the code without executing it, identifying potential issues, optimizing performance, and understanding the program's behavior. These techniques involve evaluating data flow, control flow, and type checking to determine how data moves through the program and how different parts of the code interact.

In contrast to natural language, which often contains ambiguity and relies on context for interpretation, code is inherently precise and unambiguous, providing clear instructions and definitions. This precision allows systems to learn more efficiently from code since there is less room for misinterpretation. The deterministic nature of code makes it easier to model and predict outcomes, facilitating more accurate and reliable training for autonomous models. Additionally, the limited scope of programming languages, with their well-defined syntax and semantics, reduces the complexity of the learning process. Unlike natural language, which encompasses a vast array of expressions and meanings, code adheres to strict rules and conventions, simplifying the analysis and understanding process.

The use of code, being more constrained and structured, allows for more targeted learning. The functions performed by code are specific and designed to accomplish particular tasks, making it easier for the system to identify patterns and apply them to similar problems. These constraints also enable more effective error detection and correction, as deviations from the expected behavior are easier to spot and address. Overall, the structured nature of code, combined with its clarity and precision, offers a more streamlined and efficient pathway for autonomous models to learn and perform complex tasks.

Autonomous model 106 may use leverage reinforcement learning and advanced search algorithm, optimization techniques, and/or simulation techniques to generate action graph 110. Initially, the system may define the state space, action space, and reward structure. The state space may represent all possible configurations of the environment, while the action space includes all feasible actions the agent (e.g., a user as determined by autonomous model 106) can take. The reward structure assigns values to actions or sequences of actions based on their effectiveness in achieving the goal.

For example, user profiles may serve as the foundation for understanding typical actions and decision-making processes. The system may thus define the state space (representing different user states) and action space (possible user actions) within the given environment. In some embodiments, autonomous model 106, representing the system, may interact with simulated environments that mimic real-world scenarios involving user profiles. Autonomous model 106 may explore various action sequences, learning to maximize cumulative rewards by predicting user responses and optimizing interactions. The reward structure is designed to reflect desirable outcomes, such as increased user engagement, satisfaction, or revenue.

The training process often begins with autonomous model 106 exploring the environment to gather data (e.g., from user profiles, environment characteristics, etc.). In reinforcement learning, this exploration is essential for the agent to understand the consequences of its actions. Techniques like Q-learning or deep Q-networks (DQN) are used, where autonomous model 106 learns a policy that maps states to actions by maximizing cumulative rewards. During this phase, autonomous model 106 uses a balance of exploration (trying new actions) and exploitation (using known rewarding actions) to improve its policy. Once sufficient data is collected, the system constructs initial action graphs by connecting states through actions that have been taken. These graphs are evaluated and refined through iterative processes. Algorithms like Monte Carlo Tree Search (MCTS) or heuristic search methods can be employed to prune inefficient paths and focus on more promising sequences. Autonomous model 106 continuously updates its knowledge base with new information, refining the action graphs to reflect the most efficient routes to the goal state.

The system may also incorporate mechanisms to handle uncertainties and dynamic changes in the environment. Probabilistic models and techniques such as Partially Observable Markov Decision Processes (POMDPs) can be used to account for uncertainty and incomplete information, ensuring the action graphs remain robust and adaptable. Regular validation and testing in simulated environments (sandboxing) help to ensure that the generated action graphs perform well under various scenarios and conditions. Throughout the training process, autonomous model 106 may leverage feedback loops, where the outcomes of actions are continuously fed back into the system to improve future decision-making. Advanced neural networks, particularly deep learning models, can further enhance this process by recognizing complex patterns and relationships within the state-action space. By integrating these methods, the system can generate optimized action graphs that effectively guide the agent from the starting state to the desired goal state, adapting to new challenges and improving over time.

In some embodiments, the system runs numerous simulations of different action sequences, allowing the agent to observe and evaluate the outcomes without real-world consequences. This helps in understanding the long-term effects of actions and in planning multi-step strategies. The outcomes of these simulations provide valuable data, which autonomous model 106 uses to adjust its policy and refine the action graphs.

To effectively train autonomous model 106, supervised learning techniques may be employed. The model may be trained on a dataset comprising input scenarios, corresponding queries to an LLM, and the desired contextual outputs. During training, the model learns to optimize its queries and improve its understanding of the LLM's responses. Reinforcement learning can also be utilized, where the model receives feedback on the usefulness of the contextual information provided by the LLM and adjusts its querying strategy accordingly. In some embodiments, the training process includes iterative refinement. Autonomous model 106 may be tested in various scenarios, and its performance is evaluated based on how well it uses the contextual information to make decisions. Any gaps in understanding or misinterpretations may be addressed by updating the model's querying and processing techniques. Additionally, fine-tuning the LLM on domain-specific data can improve the relevance and accuracy of the contextual information provided. Advanced techniques such as attention mechanisms and context windows may be incorporated to ensure that the autonomous model can handle long-term dependencies and maintain coherence in its queries and decision-making. These techniques help the model focus on the most relevant parts of the LLM's responses, improving the quality of the contextual information it utilizes.

In some embodiments, continuous monitoring and updating may be performed. For example, autonomous model 106 and/or its LLM may be regularly updated with new data and insights to ensure they remain effective in dynamic environments. Additionally, autonomous model 106 may query user interface 102 if there is missing data, a user query requires more information, and/or a clarification is needed.

Autonomous model 106 may also access database 114, which may include user profile data, dialogue states, API stores, etc. This database may act as a central repository, containing comprehensive user profiles, which include personal information, preferences, past interactions, and behavioral patterns. The dialogue states store the history and context of ongoing conversations, while API stores provide access to external services and functionalities that the autonomous model may need to interact with.

When a new input or query is received, autonomous model 106 may access the user profile data to personalize its responses and actions. By understanding the user's history, preferences, and specific needs, autonomous model 106 can tailor its interactions to be more relevant and engaging. For instance, in a customer service application, the model can retrieve previous support tickets or interaction logs to provide a more informed and seamless experience. Simultaneously, autonomous model 106 may use the dialogue state information to maintain context within a conversation. This allows autonomous model 106 to handle multi-turn interactions coherently, remembering past exchanges and using this information to inform future responses. By interfacing with various APIs, autonomous model 106 can extend its capabilities beyond simple data retrieval and response generation. For example, in an e-commerce application, the model might access APIs for inventory management, payment processing, or shipment tracking to provide real-time assistance to users. This integration enables autonomous model 106 to perform actions such as placing orders, checking delivery statuses, or processing payments directly through the conversation interface. To effectively manage these diverse data sources, the autonomous model employs sophisticated data handling and processing techniques. Query optimization ensures that database access is efficient, minimizing latency and improving response times. Data fusion techniques are used to combine information from multiple sources, providing a comprehensive understanding of the user and the context. Additionally, machine learning algorithms are applied to analyze and interpret the data, enabling the model to make informed and accurate decisions.

System 100 includes autonomous model 108, which may be trained to generate validation sandboxes that may test action graphs generated by the second autonomous model in order to determine whether an action graph will be successful without having to effect actual data.

For example, training a model to generate action graphs for various complex solutions is challenging due to several factors. First, the inherent complexity and variability of real-world environments make it difficult to create a comprehensive dataset that captures all possible states and actions. This complexity requires the model to generalize from limited data, often leading to issues with accuracy and robustness. Second, generating action graphs involves understanding and predicting the outcomes of a wide range of actions in dynamic and often unpredictable environments. This necessitates sophisticated modeling of cause-and-effect relationships, which can be computationally intensive and prone to errors. Another significant challenge is the need for the model to handle long-term dependencies and multi-step planning. In complex scenarios, actions taken early in the sequence can have far-reaching consequences, requiring the model to maintain a detailed understanding of the evolving state over time. This temporal aspect increases the difficulty of training, as the model must learn to balance short-term rewards with long-term objectives. Additionally, the model may need explore a vast action space to learn effective strategies, but excessive exploration can lead to inefficiencies and increased training times. The stochastic nature of many environments adds another layer of difficulty. Randomness and uncertainty in outcomes necessitate the model to develop robust strategies that can adapt to varying conditions. This requires advanced probabilistic reasoning and the ability to anticipate and mitigate the impact of unexpected events. Finally, ensuring that the generated action graphs are interpretable and align with human understanding and decision-making processes is crucial, adding an additional constraint to the model training.

In view of these challenges, the system uses autonomous model 108 to generate sandbox validations for the action graphs developed by autonomous model 106. For example, sandbox validation helps mitigate the difficulty in training the model to generate action graphs for various complex solutions by providing a controlled, simulated environment where the model can be tested and refined before deployment in real-world scenarios. For example, the sandbox allows for the creation of a controlled environment where variables can be managed, and specific scenarios can be replicated consistently. This controlled setting makes it easier to identify and correct errors, ensuring that the model performs reliably under known conditions. Additionally, by testing the action graphs in a sandbox, developers can observe how it behaves in complex situations without the risk of negative consequences in the real world. This is particularly important for high-stakes applications where errors could lead to significant harm or loss. Sandbox validation also supports an iterative process of testing and refinement. Developers can run multiple simulations, observe the outcomes, and adjust the model as needed. This iterative cycle helps to progressively improve the model's accuracy and robustness in generating action graphs. In a sandbox, a wide range of scenarios, including long-term scenario, edge cases, and/or rare events, can be simulated. This helps the model learn to handle complexity and variability, improving its generalization capabilities when exposed to real-world conditions.

Training a system to generate validation sandboxes that can test action graphs generated by autonomous model 108 may involve creating sophisticated simulated environments that accurately mimic real-world conditions without affecting actual data. Autonomous model 108 may begin with gathering comprehensive data and understanding the critical variables and dynamics of the real-world environment. This data is used to build detailed models of the environment, including all relevant states, actions, interactions, and outcomes.

The next step is to design the sandbox environment itself. This involves creating a virtual setting where the autonomous model can operate, ensuring that it includes the complexity and variability of the real world. Advanced simulation techniques, such as agent-based modeling and system dynamics, may be employed to replicate the behavior of different entities and interactions within the environment. The sandbox must be capable of representing various scenarios, including typical, rare, and edge cases, to thoroughly test the robustness and effectiveness of the action graphs.

Once the sandbox environment is established, the system integrates the autonomous model, allowing it to execute its action graphs within this simulated space. Reinforcement learning methods may be used here, where autonomous model 108 interacts with the sandbox, making decisions, and receiving feedback based on the simulated outcomes. The reward structures in these simulations are designed to mirror the objectives of the real-world tasks, such as maximizing efficiency, minimizing risk, or achieving specific performance targets.

The system then runs extensive simulations, where the autonomous model's action graphs (e.g., action graph 110) are tested under various conditions. These simulations allow the model to explore the consequences of its actions without impacting real data. By observing the outcomes, the system can evaluate the success and failure of different action graphs, identifying potential weaknesses and areas for improvement. This iterative testing process helps refine the action graphs, ensuring they are optimized for real-world application.

To ensure the sandbox simulations are realistic and reliable, the system may use advanced techniques like Monte Carlo simulations to account for randomness and uncertainty, and Partially Observable Markov Decision Processes (POMDPs) to handle incomplete information. These techniques enhance the robustness of the validation process, making the simulated outcomes more predictive of real-world performance. Visualization tools may also be integrated to provide clear insights into the simulation results. Graphs, dashboards, and interactive interfaces help stakeholders understand how the action graphs perform in the sandbox, highlighting key metrics and potential issues. The system may constantly update the sandbox environment and autonomous model 108 based on new data and insights gained from the simulations. This dynamic approach ensures that both the validation sandbox and the action graphs evolve over time, adapting to new challenges and improving their effectiveness.

Moreover, as autonomous model 108 may be used to validate action graphs to generate validated action graphs (e.g., validated action graph 112), the validated action graphs and their associated modification if any, may be implemented directly as code script. As these changes are already compartmentalized based on the use of the multi-autonomous model architecture, the system may enter these graph characteristics and/or modifications directly into the autonomous model 104 to generate responses describing each individual portion of the action graph that are presented on user interface 102.

System 100 may use explainer agent 116 to supplement responses transmitted to user interface 102. For example, system 100 may process outputs from validated action graph 112 through explainer agent 116 that provides responses to one or more queries receiving via user interface 102. For example, system 100 may provide responses to an initial user query received via user interface 102. Explainer agent 116 may use its own LLM to further describe characteristics of the processes and workflows that generated the response.

In system 100, explainer agent 116 may enhance the responses delivered through user interface 102 by providing supplementary, context-rich information. For example, when system 100 processes outputs from the validated action graph 112, it leverages explainer agent 116 to interpret and explain the outputs in response to specific user queries received via user interface 102. This process allows for a two-layered response approach: an initial response is generated by system 100 to address the user's query, while explainer agent 116 provides an added layer of understanding. Using its own LLM, explainer agent 116 expands on the initial response by detailing relevant characteristics of the underlying processes, workflows, and any complex actions that were instrumental in generating the response. Through this mechanism, system 100 not only addresses the user's immediate question but also offers additional insights, ensuring that the user gains a comprehensive understanding of the response's origin and the system's operational nuances.

Explainer agent 116 may comprise several key components designed to interpret and articulate system processes effectively. Central to its function is a dedicated LLM that enables it to generate descriptive, contextually relevant explanations of complex system workflows. Additionally, explainer agent 116 may include a query interpretation module, which identifies and categorizes user questions to ensure that responses are tailored to the user's intent. It may also incorporate a process analysis component that accesses and evaluates data from validated action graph 112, allowing it to understand and explain the specific operations, decision points, and outcomes involved. Furthermore, a context retrieval module may be present to gather relevant historical data, system logs, or metadata that can enrich the response. Together, these components enable explainer agent 116 to not only respond accurately to user queries but also to provide comprehensive, transparent explanations that enhance the user's understanding of system 100's processes.

Explainer agent 116 is trained through a combination of supervised learning, reinforcement learning, and iterative feedback to ensure its responses are accurate, contextually relevant, and aligned with the system's processes. During initial training, explainer agent 116 is exposed to a dataset of system-specific queries and responses that are carefully annotated by experts. This data includes explanations of various processes, workflows, and outcomes that may arise from interactions with validated action graph 112. The training process also incorporates reinforcement learning, where the explainer agent receives feedback based on the quality of its explanations, helping it refine its responses over time. Furthermore, the agent may be continuously updated with new data from system logs, user interactions, and evolving workflows within system 100. This ongoing training helps the agent adapt to changes in system processes, ensuring that its explanations remain accurate and insightful. Periodic human-in-the-loop evaluations may also be employed, allowing experts to assess and correct the agent's responses, which further improves its ability to clarify complex processes effectively for users.

In some embodiments, each model and/or agent (e.g., autonomous model 104, autonomous model 106, autonomous model 108, and/or explainer agent 116) may use reflection and/or regenerative learning. For example, each model and agent within the system, including autonomous models 104, 106, and 108, as well as explainer agent 116, utilizes reflection and regenerative learning to continuously enhance their performance, adaptability, and accuracy. Autonomous models 104, 106, and 108 employ reflection to evaluate their previous actions and outputs, identifying areas where predictions or decisions may have diverged from desired outcomes. Through regenerative learning, they incorporate these insights to adjust their internal parameters, refine their decision-making processes, and improve future responses. This enables them to better align with the objectives of validated action graph 112 and to more effectively address complex or evolving user needs. Explainer agent 116 also utilizes reflection by assessing the clarity and accuracy of its past explanations, based on user interactions and feedback. Through regenerative learning, it adapts to improve the relevance and detail of its explanations, drawing on updated process data, user feedback, and expert reviews. By continuously learning from each interaction, all models within the system become progressively more sophisticated, enabling system 100 to provide increasingly accurate, transparent, and insightful responses across varied user interactions.

In some embodiments, each model and/or agent (e.g., autonomous model 104, autonomous model 106, autonomous model 108, and/or explainer agent 116) may use a rule based evaluator and/or an LLM based evaluator to generate outputs. For example, each model and agent in the system, including autonomous models 104, 106, and 108, as well as explainer agent 116, may use a combination of rule-based evaluators and LLM-based evaluators to produce high-quality outputs tailored to user needs and system requirements. Rule-based evaluators allow each model to apply structured criteria and predefined rules when assessing data, actions, and decisions. This is particularly valuable for tasks that require strict adherence to policies, thresholds, or operational constraints defined within validated action graph 112. By following these fixed rules, the models can ensure consistency and compliance in situations where certain decisions are non-negotiable. Meanwhile, LLM-based evaluators provide flexibility and adaptability by assessing outputs in a broader, context-aware manner. Autonomous models 104, 106, and 108 may use LLM-based evaluators to interpret ambiguous user inputs or to optimize responses based on historical patterns and contextual nuances that go beyond rigid rule sets. Explainer agent 116 leverages an LLM-based evaluator to assess the quality of explanations, ensuring they are comprehensive and user-friendly by interpreting user queries and adapting responses in a more conversational and informative way. Together, rule-based and LLM-based evaluators allow the models and agents within system 100 to produce outputs that are both compliant with predefined criteria and responsive to user needs, balancing structure and flexibility in real-time.

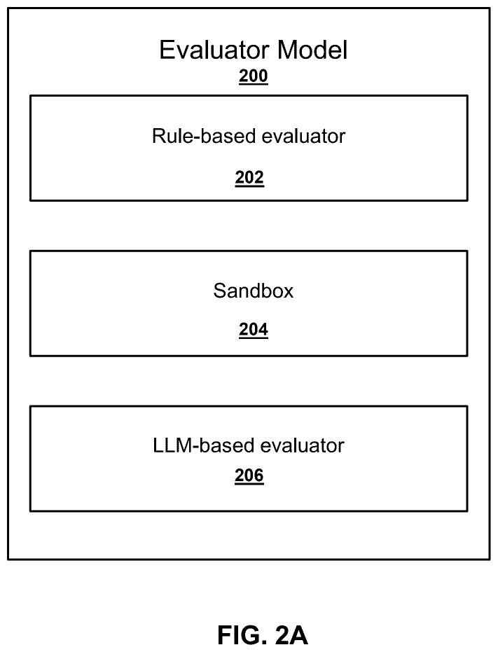

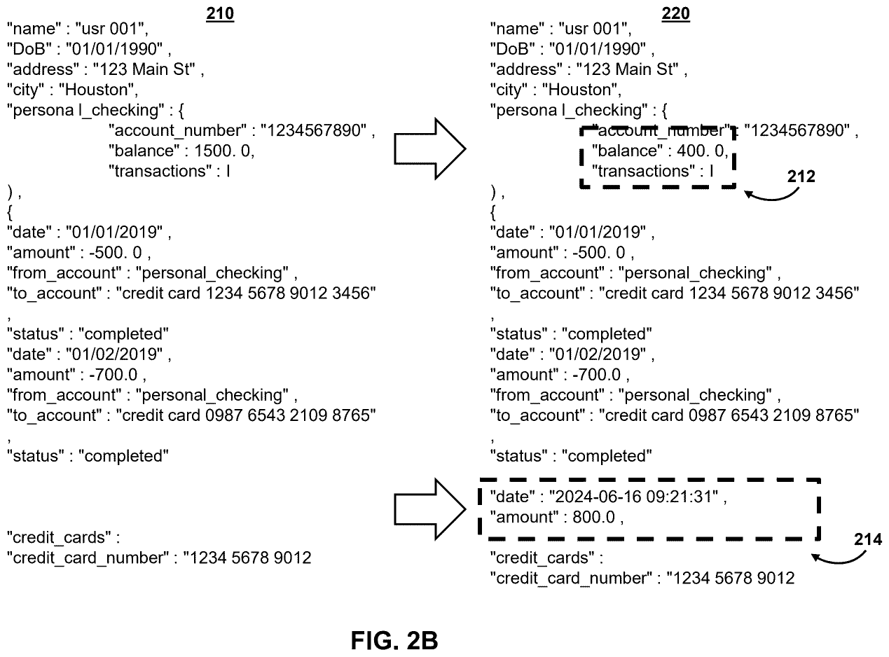

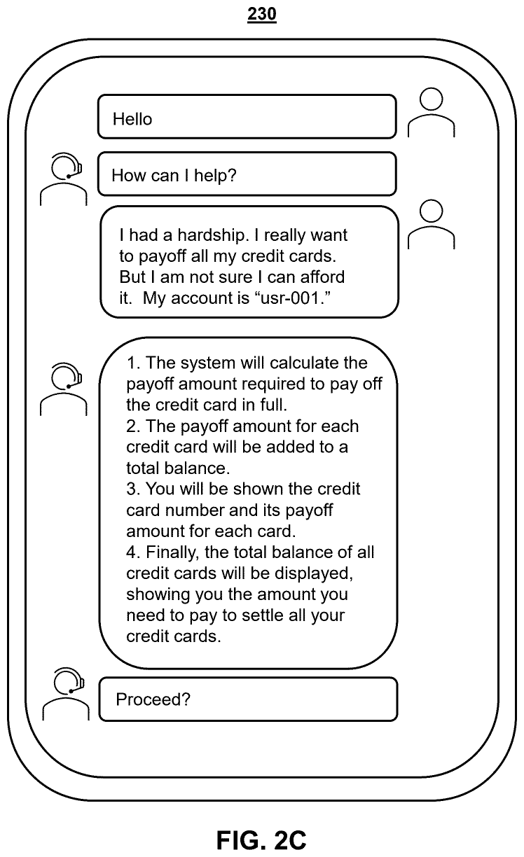

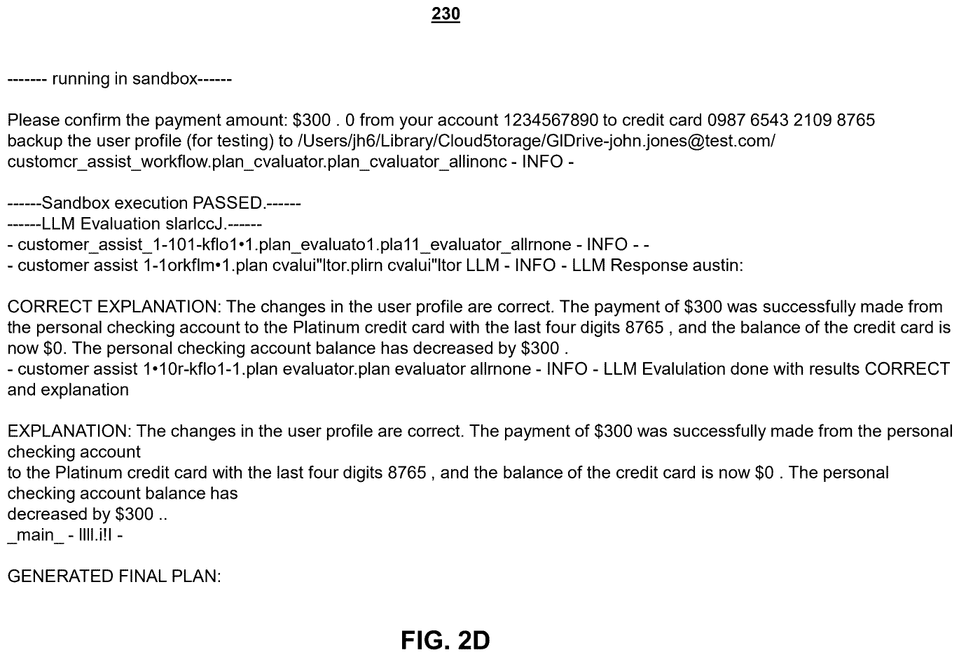

FIGS. 2A-2D shows an illustrative diagram for an evaluator model, in accordance with one or more embodiments. For example, FIG. 2A illustrates a diagram of evaluator model 200, which in some embodiments may correspond to autonomous model 108 (FIG. 1). In should also be noted that in some embodiments, the structure and/or components of evaluator model 200 may be shared by other autonomous models in a multi-autonomous model architecture.

As shown in FIG. 2A, evaluator model 200 includes rule-based evaluator 202, which may comprise functions and/or application programming interfaces (APIs) for use. In some embodiments, the functions and/or APIs may be listed on a whitelist. Evaluator model 200 may process a first action graph with an autonomous evaluation model to generate a first validated action graph by: generating a sandbox session for the first action graph; retrieving a user profile for a user; populating the sandbox session with user profile data from the user profile; and testing the first action graph in the sandbox session to determine whether the first action graph results in a requested final state. Evaluator model 200 may then generating a first response to the first user query based on the first validated action graph.

For example, evaluator model 200 may process a first action graph using an autonomous evaluation model to ensure it meets all necessary criteria before generating a first validated action graph. Initially, evaluator model 200 creates a sandbox session dedicated to testing the first action graph in an isolated, controlled environment. This sandbox session serves as a testing ground where the system can safely simulate the action graph's potential outcomes without affecting live data or production environments. Once the sandbox session is established, evaluator model 200 retrieves a user profile corresponding to the user who submitted the query, capturing relevant data such as preferences, historical interactions, permissions, and any personalized settings that may influence the action graph's execution. This user profile data is then populated into the sandbox session, allowing the evaluator to test the action graph in a context that closely mirrors the actual conditions and user-specific variables.

With the sandbox session fully configured, evaluator model 200 proceeds to test the first action graph by executing each action and evaluating whether the sequence leads to the intended final state requested in the user's query. During this simulation, the autonomous evaluation model assesses the performance, efficiency, and logical coherence of the action graph's steps, identifying potential issues such as conflicts, inefficiencies, or non-compliant actions. If the action graph successfully achieves the requested final state without errors, it is deemed valid and is approved as the first validated action graph.

Once the first validated action graph is generated, evaluator model 200 uses it to produce a first response to the initial user query. This response draws directly from the validated action paths and outcomes, ensuring that it reflects a reliable plan aligned with both system capabilities and the user's specific needs. By relying on the validated action graph, evaluator model 200 can provide the user with a precise, actionable response, backed by a thorough simulation that confirms the proposed actions lead to the intended result. This method ensures that the response is both accurate and tailored to the user, resulting in a robust and user-focused answer to the initial query.

For example, evaluator model 200 may use rule-based evaluator 202, which may include functions and APIs listed on a whitelist, to assess and validate the actions, decisions, and outputs of an autonomous system. The rule-based evaluator may operate by following predefined rules and criteria to ensure that the system's behavior aligns with specified standards, guidelines, and objectives. This integration begins by defining a set of rules that capture the desired behaviors and constraints. These rules are encoded into functions and are often linked to APIs that provide additional data or perform specific checks.

When the autonomous model proposes an action or generates an output, the evaluator model invokes the rule-based evaluator to assess its validity. The evaluator retrieves relevant functions and APIs from the whitelist, ensuring that only authorized and trusted operations are performed. This whitelist acts as a security measure, preventing the use of unapproved or potentially harmful functions and APIs. Each proposed action or output is processed through these functions, where the rule-based evaluator checks for compliance with the predefined criteria. For example, in a financial application, the evaluator might use rules to ensure that transactions do not exceed certain limits, adhere to regulatory requirements, or comply with user-specific constraints. APIs might be called to verify user credentials, check account balances, or validate transaction details. By using a combination of local functions and external APIs, the evaluator model can thoroughly assess the proposed actions, ensuring they are both valid and safe.

The rule-based evaluator also provides feedback to the autonomous model. If an action or output is deemed invalid, the evaluator can specify which rules were violated and suggest corrective actions. This feedback loop helps the autonomous model learn and improve its decision-making process over time, gradually reducing the frequency of invalid actions and enhancing overall performance. To handle complex and dynamic scenarios, the evaluator model may be designed to update its rule set and whitelist periodically. This allows it to adapt to new regulations, incorporate additional functions, and extend its capabilities. Moreover, it can log evaluation results for auditing purposes, providing transparency and traceability of decisions.

Evaluator model 200 may also use sandbox 204 (e.g., to validate action graphs), which may involve collecting data related to user profiles, current environmental conditions (e.g., interest rates, default rates, stated objectives, etc.). Evaluator model 200 may use sandbox 204 to generate a test of an action graph.

FIG. 2B illustrates script modified by the system (e.g., evaluator model 200 (FIG. 2A)). For example, evaluator model 200 may use sandbox 204 to create a sandbox environment to validate action graphs by creating a controlled, simulated setting where proposed actions can be tested against realistic scenarios without affecting real-world data. This validation process involves several key steps to ensure the robustness and efficacy of the action graphs generated by the autonomous model.

For example, evaluator model 200 may process a first action graph with an autonomous evaluation model to generate a first validated action graph by: determining a first update to the first action graph required to generate the first validated action graph; processing the first update using a large language model to generate a second code script corresponding to the first update; and updating first code script with the second code script. Evaluator model 200 may generate a first response to the first user query based on the first validated action graph.

For example, evaluator model 200 processes a first action graph with an autonomous evaluation model to generate a validated and optimized response by identifying and implementing necessary updates. Initially, the autonomous evaluation model analyzes the first action graph, identifying any adjustments required to align it with system standards, user goals, or specific constraints. These modifications, or “updates,” are defined in detail; for example, a first update may involve refining certain steps within the action graph to enhance efficiency, ensure compliance, or correct logical errors. Once evaluator model 200 identifies this first update, it employs a LLM to generate a second code script that corresponds precisely to the needed modifications. The LLM interprets the desired changes and creates a code script that enacts the specified update, ensuring that the second code script is compatible with the original structure of the action graph.

After generating the second code script, evaluator model 200 proceeds to integrate it with the initial code (the first code script) underlying the first action graph, effectively updating and enhancing the action graph with the new instructions. This updated script now represents an optimized action path, verified to meet the user's request and the system's operational criteria. The modified action graph, now the first validated action graph, is thus prepared for execution or response generation.

Using this first validated action graph, evaluator model 200 then generates a response to the initial user query. By following the refined and verified action paths within the validated action graph, the evaluator model ensures that the response directly reflects a reliable and optimized solution to the user's query. This validated response is designed not only to fulfill the original request accurately but also to offer an efficient, system-aligned solution, leveraging the updates and refinements introduced during evaluation. The end result is a response that incorporates both the user's intent and the system's best practices, ensuring high quality and relevance in addressing the user's needs.

Evaluator model 200 may collect relevant data necessary for accurate simulation within the sandbox. This data includes detailed user profiles, capturing personal information, historical behaviors, preferences, and specific objectives. Additionally, current environmental conditions, such as interest rates, default rates, and market trends, are incorporated to reflect the real-world context in which the actions will be executed. By using up-to-date and comprehensive data, the sandbox can simulate realistic conditions that closely mimic the actual operating environment.

Once the sandbox environment is set up, evaluator model 200 may run the action graphs generated by the autonomous model within this controlled setting using LLM-based evaluator 206. For example, the action graphs represent sequences of actions designed to achieve specific goals, and the sandbox allows these actions to be executed in a risk-free manner. Evaluator model 200 monitors the outcomes of these actions, assessing their effectiveness and identifying any potential issues or unforeseen consequences. During this process, the sandbox collects extensive data on how the action graphs perform under various conditions. It tracks key performance indicators (KPIs) relevant to the stated objectives, such as financial returns, user satisfaction, compliance with regulatory requirements, and risk levels. Evaluator model 200 may analyze this data to determine whether the actions produce the desired outcomes and meet the predefined criteria.

If the actions fail to achieve the desired results or violate any constraints, evaluator model 200 provides detailed feedback, highlighting the specific areas of concern and suggesting improvements. This feedback loop allows the autonomous model to refine its action graphs iteratively, enhancing their performance and reliability. Additionally, the sandbox environment can simulate a wide range of scenarios, including best-case, worst-case, and average conditions. This comprehensive testing ensures that the action graphs are robust and can handle various contingencies. Evaluator model 200 may use these simulations to stress-test the action graphs, ensuring they can adapt to different user behaviors and changing environmental conditions. By leveraging a sandbox for validation, the evaluator model ensures that the action graphs are thoroughly vetted before being deployed in real-world applications. This approach minimizes risks, enhances decision-making accuracy, and ensures that the actions proposed by the autonomous model are both effective and compliant with all relevant standards and objectives. Through continuous validation and refinement within the sandbox, the system can maintain high levels of performance and reliability, ultimately leading to better outcomes in actual deployment.

As shown in FIG. 2B, an evaluator model (e.g., evaluator model 200 (FIG. 2B)) may be used to generate new code and/or script (e.g., using an LLM) to reflect an action graph and/or modifications to an action graph. For example, an evaluator model may be used to validate action graphs to generate validated action graphs. In such cases, the validated action graphs and their associated modification if any, may be implemented directly as code script. As these changes are already compartmentalized based on the use of the multi-autonomous model architecture, the system may enter these graph characteristics and/or modifications directly into the code (e.g., using an LLM). For example, as shown in FIG. 2B, the system may make modifications to the code of action graph 210 to generate code for a validation action graph 220.

As shown in FIG. 2B, the system may make modifications to a value in the code (e.g., value 212) and/or may add entirely new functions (e.g., function 214). For example, the system may make modifications to a value in the code of an action graph or add entirely new functions using a large language model (LLM) by leveraging the LLM's ability to understand and generate human-like code based on given instructions.

For example, the system may identify the specific values or functions within the action graph code that require modification or addition. The system may identify these values based on a user input (e.g., via a user interface) and/or a determination that an action graph cannot be validated with a current value.

For example, the system may iteratively change values in an action graph (or code representing an action graph) based on an objective represented by another value of the action graph to validate the action graph through a process involving continuous feedback and optimization. This iterative process may begin with defining the objective clearly, such as maximizing efficiency, minimizing risk, or achieving a specific performance target. The objective is quantified and represented by a key metric or value within the action graph.

The system may establish a baseline by executing the action graph with its current set of values and measuring the resulting performance against the defined objective. This baseline performance may provide a reference point for evaluating the impact of subsequent changes. The system then identifies the key variables within the action graph that influence the objective.

Using an optimization algorithm, such as gradient descent, genetic algorithms, or reinforcement learning, the system may make incremental adjustments to these variables. After each adjustment, the action graph is re-executed, and the system measures the resulting performance. The feedback from this execution is compared to the objective value to determine whether the change led to an improvement.

If the performance improves, the system continues to adjust the values in the same direction, exploring further optimizations. If the performance declines or remains unchanged, the system adjusts the values in a different direction or explores alternative variables. This process is repeated iteratively, with the system continuously learning from each iteration and refining the action graph's values to move closer to the objective.

Throughout this iterative process, the system employs various techniques to ensure robust validation. This includes cross-validation, where the action graph is tested in different scenarios and conditions to verify that the improvements are generalizable and not specific to a particular set of circumstances. The system also uses sensitivity analysis to understand the impact of each variable on the objective, helping to prioritize which values to adjust.

Additionally, the system maintains detailed logs and records of each iteration, capturing the changes made, the resulting performance, and the contextual factors influencing the outcome. This documentation is crucial for understanding the optimization process and for making informed decisions about further modifications. By iteratively changing values in the action graph and continuously validating against the objective, the system can optimize the action graph effectively. This iterative approach allows the system to adapt to new data, evolving conditions, and changing objectives, ensuring that the action graph remains aligned with the desired outcomes and performs optimally in real-world applications.

This identification can be driven by performance feedback, new requirements, and/or changes in the operating environment. The system then formulates a natural language instruction detailing the desired changes, such as updating a threshold value, adding a new decision-making function, or incorporating a new data processing method. Next, the system inputs this instruction into the LLM, which is pre-trained on a vast corpus of code and technical documentation. The LLM processes the instruction, leveraging its understanding of programming languages and coding patterns to generate the necessary code modifications or new functions. For instance, if the instruction is to change an interest rate threshold from 5% to 6%, the LLM will identify the relevant part of the action graph code and make the appropriate adjustment. If the task involves adding a new function, such as a method to calculate risk based on new parameters, the LLM will generate the entire function code, complete with appropriate syntax and logic.

After the LLM generates the modified code or new function, the system integrates this code back into the action graph. This integration involves updating the existing codebase and ensuring that the new or modified sections are correctly linked and functional within the broader context of the action graph. The system then runs a series of automated tests to validate the changes. These tests check for syntax errors, logical consistency, and performance impacts to ensure that the modifications enhance the action graph's functionality without introducing new issues.

Furthermore, the system employs version control practices to track changes made by the LLM. This allows for easy rollback if the modifications do not produce the desired outcomes or if they negatively impact the system's performance. The version control system maintains a history of changes, facilitating continuous improvement and iterative development. By utilizing an LLM to modify values or add functions to the code of an action graph, the system can efficiently adapt to new requirements and improve its decision-making capabilities. This approach combines the LLM's powerful code generation capabilities with robust testing and integration processes, ensuring that the action graph remains accurate, functional, and aligned with the system's overall goals.

As these changes are already compartmentalized based on the use of the multi-autonomous model architecture, the system may enter these graph characteristics and/or modifications directly into the code (e.g., using an LLM) to generate responses describing each individual portion of the action graph that are presented on user interface 102.

FIG. 2C illustrates a user interface presenting responses to user queries, which in some embodiments may correspond to user interface 102 (FIG. 1). For example, as shown in user interface 230, a user may interact with an agent, chatbot, etc. Using user interface 230, a user may provide the system with user profile characteristics (e.g., a user account) as well as an objective of the user interface interaction (e.g., settle credit card bills). Based on this user interface interaction, the system (e.g., system 100 (FIG. 1)) may determine specific values for inputting to a potential action graph as well as determine what information, if any, needs to be retrieve from another source (e.g., database 114 (FIG. 1)).

User interface 230 may issue queries and receive responses to determine user profile characteristics and the objectives of user interactions by providing an interactive and intuitive platform for users to input their information and specify their goals. The process may begin with the user logging into the system through the user interface 230, where the user may be prompted to provide authentication details such as username and password, ensuring secure access to their account. Once logged in, the system can access the user's profile data, including personal information, transaction history, preferences, and other relevant details stored in the database.

To determine the objectives of the user interaction, user interface 230 may present a series of guided queries tailored to elicit specific information about the user's needs. For example, if the user intends to settle credit card bills, the system might ask questions about the outstanding balance, preferred payment method, and any specific payment schedules. These queries may be designed to be clear and user-friendly, encouraging users to provide accurate and detailed responses.

As the user interacts with user interface 230, the system collects and analyzes the input to extract meaningful data points. For instance, the system identifies key values such as the amount to be paid, the payment date, and any special instructions from the user's responses. These values are critical for constructing a potential action graph that outlines the steps necessary to fulfill the user's objective.

Additionally, the system may determine that certain information needs to be retrieved from other sources to complete the action graph accurately. For example, if the user needs to verify their account balance or check recent transactions, the system will issue queries to the relevant APIs or databases to fetch this information. The retrieved data is then integrated into the action graph, ensuring that all necessary inputs are available to generate a comprehensive plan.

The system continuously updates user interface 230 to reflect the current state of the interaction, providing real-time feedback and additional prompts as needed. This dynamic interaction helps the user navigate through the process efficiently, ensuring that all relevant information is captured. For example, if the user expresses an interest in setting up automatic payments for their credit card bills, user interface 230 can prompt for additional details such as frequency and maximum payment limits.

Once all necessary information is gathered, the system uses the input data to construct an action graph that maps out the steps required to achieve the user's objective. This action graph is then validated using predefined rules and, if necessary, sandbox environments to ensure its feasibility and accuracy. The system may also provide a summary of the proposed actions to the user via user interface 230, allowing for confirmation or adjustments before execution. User interface 230 may further use the LLM to describe any graph characteristics and/or modifications made directly into the code. For example, as shown in FIG. 2C, the system may generate queries and/or responses that describe modifications to the code of an action graph.

In some embodiments, the system initiates a first device session between a first mobile device and one or more servers comprising the multi-autonomous model architecture, determines a user corresponding to the first mobile device, and retrieves a user profile corresponding to the user. For example, system initiates a first device session between a first mobile device and one or more servers comprising the multi-autonomous model architecture by first establishing a secure communication channel. This may involve the mobile device sending a session initiation request to the servers, which then authenticate the request using standard protocols such as OAuth or similar authentication mechanisms. Upon successful authentication, the servers and the mobile device establish a session, enabling continuous and secure data exchange.

Once the session is initiated, the system determines the user corresponding to the first mobile device. This identification process can be achieved through various methods such as verifying the user's login credentials, utilizing biometric data, or recognizing unique device identifiers associated with the user's account. By employing these authentication measures, the system accurately identifies the user operating the mobile device.

Following user identification, the system retrieves the user profile corresponding to the identified user. The user profile, stored in a centralized or distributed database accessible by the servers, contains pertinent information such as user preferences, historical interactions, and personalized settings. The system queries this database using the unique user identifier obtained during the authentication process, retrieving the relevant profile data. This data is then used to tailor the session experience, ensuring that the services and interactions provided during the session are personalized and aligned with the user's preferences and history. This comprehensive process ensures a secure, personalized, and efficient session initiation and management.

As shown in FIG. 2D, the system may generate sandbox environments and perform action graph validations. Script 240 shows an example of script used to test an action graph as well as a response generated in response to the test. For example, script 240 may comprise a first code script as updated with the second code script, wherein the first response comprises a first description describing the second code script and/or a result of a validation of the code script.

For example, as shown in script 240, the system retrieves the user's profile data and the current state characteristics, which provide context and personalization to the response. Next, it processes the query to identify the specific updates needed, incorporating the second code script into the first. The system then modifies the action graph characteristics to reflect these changes, ensuring that the graph accurately represents the updated script's logic and flow. Additionally, the system performs various validations to ensure the integrity and functionality of the combined code scripts. These validations might include syntax checks, compatibility assessments, and performance evaluations. The results of these validations are also incorporated into the response. Finally, the system compiles this information into a comprehensive description, explaining how the second code script was integrated into the first and detailing any modifications to the action graph, along with the outcomes of the validations performed. This structured response is then displayed to the user, providing a clear and detailed overview of the updates made to the code script.

The system may then use an LLM to describe the process of generating an updated code script in response to a user query, it outlines several key steps. The LLM begins by explaining that the system retrieves the user's profile data and current state characteristics to tailor the response to the user's context. It then processes the user's query, identifying the need to incorporate a second code script into the first. The LLM describes how the system modifies the action graph characteristics to accurately represent the changes brought about by merging the two scripts. It also highlights the importance of performing validations, such as syntax checks and compatibility assessments, to ensure the combined script's functionality and integrity. The outcomes of these validations are noted as part of the process. Finally, the LLM conveys how this information is compiled into a detailed description, which includes an explanation of how the second script was integrated into the first, modifications to the action graph, and the results of the validations. This comprehensive description is then presented to the user, providing a clear and informative overview of the script update process.

In some embodiments, the system may generate various tests prior to generating a sandbox session. For example, testing action graph results in a sandbox environment poses several technical challenges. First, replicating the exact production environment within a sandbox can be difficult due to differences in configurations, data sets, and dependencies. These discrepancies can lead to inaccurate testing outcomes, as the sandbox might not fully capture the complexities and nuances of the live environment. Additionally, action graphs often involve dynamic and interactive components that interact with various external systems, databases, and services. Simulating these interactions accurately in a sandbox requires extensive mock setups and stubs, which can be time-consuming and prone to errors.

Another challenge is ensuring data consistency and integrity. Sandboxes typically use isolated data sets to prevent interference with production data, but this isolation can result in tests that don not fully reflect real-world scenarios. Furthermore, some actions within the graph may depend on real-time data or user interactions that are difficult to simulate accurately in a sandbox.

Performance testing is also a concern, as sandboxes may not have the same resource allocation as production environments, leading to performance metrics that do not accurately reflect actual user experiences. Lastly, maintaining and updating the sandbox environment to keep it in sync with production changes requires ongoing effort and can introduce additional complexity and potential for discrepancies. These factors combined make testing action graph results in a sandbox both technically challenging and resource-intensive.

In response the system may test a simulation level, resource allocation, and/or one or more performance metrics of a potential sandbox session (or the components used to generate the sandbox session) prior to generating the sandbox session for validating action graphs. For example, the system may model the simulation environment by replicating key characteristics of the production environment, including network configurations, data sets, and dependencies. It then allocates resources by simulating the same resource constraints and availability as the production system, ensuring the sandbox can effectively mimic real-world conditions.

To validate the sandbox session, the system runs preliminary tests on individual components and their interactions, focusing on critical performance metrics such as response times, throughput, and resource utilization. These tests are conducted using a subset of real-world scenarios to assess whether the sandbox environment meets predefined thresholds for performance and resource allocation. The system compares these metrics against established benchmarks to identify any discrepancies or potential issues.

Additionally, the system employs monitoring tools to track resource usage and performance metrics continuously during the preliminary tests. This data is analyzed to ensure that the sandbox environment can handle the expected load and perform reliably under various conditions. If the initial tests indicate that the sandbox environment meets or exceeds the required thresholds, the system proceeds to generate the full sandbox session for validating action graphs. Otherwise, adjustments are made to the simulation parameters or resource allocation, and the tests are repeated to achieve the desired accuracy and reliability. This thorough pre-generation testing ensures that the sandbox environment is robust and capable of providing meaningful validation for action graphs.

To test a first action graph in a sandbox session and determine if it results in the requested final state, a system follows a methodical process. Initially, the system deploys the action graph within the sandbox environment, which replicates the production environment as closely as possible. The sandbox session is configured with the same inputs, data sets, and dependencies that the action graph would encounter in a live scenario. The system then executes the action graph, carefully monitoring each step and interaction.

During execution, the system captures detailed logs and metrics to track the progression of the action graph. It compares the intermediate states and outputs at various checkpoints against expected values to ensure that each step is performing correctly. The system also applies validation rules and assertions defined for the requested final state, checking for consistency, correctness, and completeness.

After the action graph completes its execution, the system evaluates the final state against the predefined criteria for success. This involves comparing the final state produced by the action graph with the requested final state, using metrics such as data integrity, state transitions, and output accuracy. If discrepancies are found, the system analyzes the logs to identify the root causes, which may involve tracing back through the action graph's steps to pinpoint where deviations occurred.

The system may also run additional tests to assess the robustness and reliability of the action graph under different conditions and edge cases. If the action graph consistently results in the requested final state across these tests, the system confirms its validity. Otherwise, it flags the issues for further investigation and refinement. This comprehensive testing process ensures that the action graph functions as intended and achieves the desired final state in a controlled and reliable manner.

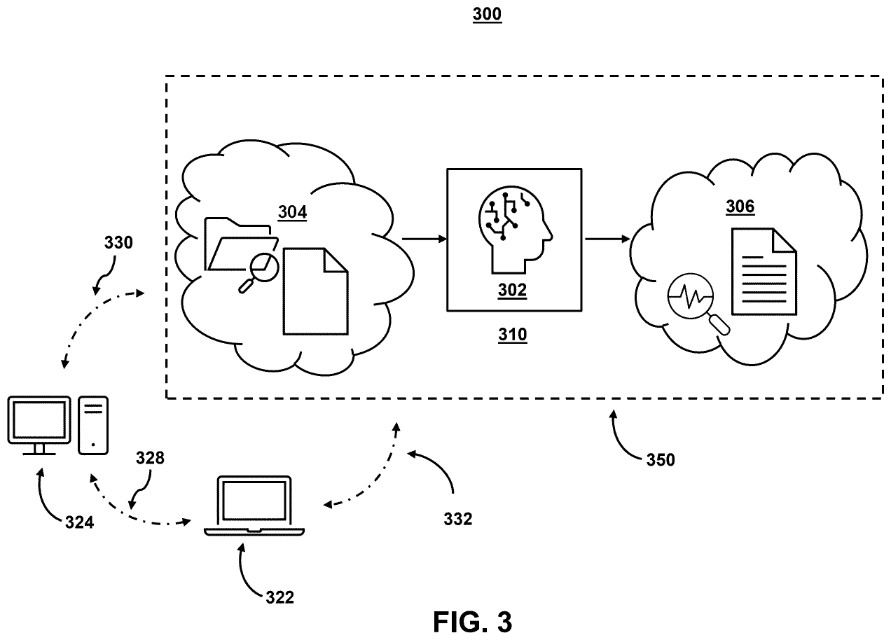

FIG. 3 shows illustrative components for a system used to multi-autonomous model architecture, in accordance with one or more embodiments. For example, FIG. 3 may show illustrative components for one or more autonomous model in a multi-autonomous model architecture. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., an action graph, a graph characteristic, a graph value, an objective, etc.).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., an action graph, a graph characteristic, a graph value, an objective, etc.).

In some embodiments, the model (e.g., model 302) may automatically perform actions based on outputs 306. In some embodiments, the model (e.g., model 302) may not perform any actions. The output of the model (e.g., model 302) may be used to generate a response in a user interface.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open-source API Platforms and their modules. API layer 350 may use a developer portal. API layer 350 may use strong security constraints applying WAF and DDoS protection, and API layer 350 may use RESTful APIs as standard for external integration.

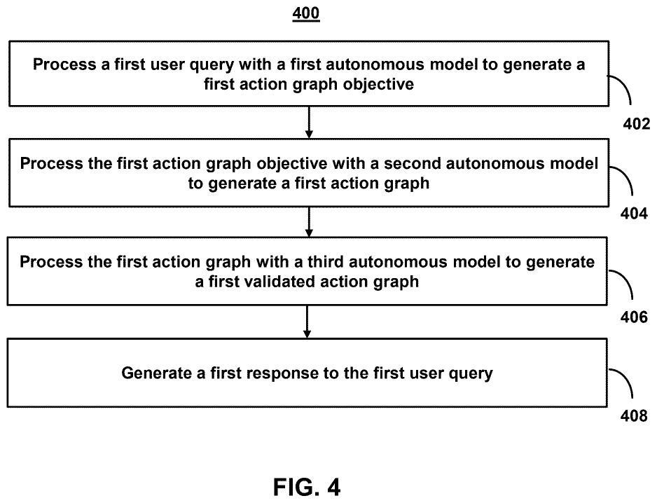

FIG. 4 shows a flowchart of the steps involved in using multi-autonomous model architectures, in accordance with one or more embodiments. For example, the system may use process 400 (e.g., as implemented on one or more system components described above) in order to generate complex responses to user queries received via a user interfaces. For example, in some embodiments, process 400 may be performed by system 100 (FIG. 1) using autonomous model 104 (FIG. 1), autonomous model 106 (FIG. 1), and/or autonomous model 108 (FIG. 1).

At step 402, process 400 (e.g., using one or more components described above) process a first user query with a first autonomous model to generate a first action graph objective. For example, the system may receive, at a user interface, a first user query. The system may process the first user query with a first autonomous model of a multi-autonomous model architecture, to generate a first action graph objective, wherein the first autonomous model is trained using a first large language model to determine contextual information in order to determine action graph objective outputs for inputted user queries.

In some embodiments, training the first autonomous model using the first large language model to determine the contextual information in order to determine the action graph objective outputs for the inputted user queries may comprise generating a first set of training data for the contextual information comprising labeled action graph objective outputs for labeled contextual information, retrieving the first large language model, wherein the first large language model is pre-trained to process the inputted user queries to determine the labeled contextual information, and re-training the first large language model, using the first set of training data, to generate the labeled action graph objective outputs for the labeled contextual information.

For example, the system trains a first autonomous model using a LLM to determine contextual information and action graph objective outputs for inputted user queries through a systematic training process. The system may generate a first set of training data that includes labeled contextual information paired with corresponding labeled action graph objective outputs. This training data serves as the foundation for teaching the model how to interpret user queries and determine the necessary outputs. The system then retrieves the first large language model, which has been pre-trained on a vast corpus of data to understand and process natural language input. This pre-trained model is already capable of interpreting user queries and extracting relevant contextual information. However, to tailor the model to the specific task of generating action graph objective outputs, further training is required. To do so, the system re-trains the pre-trained large language model using the first set of training data. During this re-training phase, the model is fine-tuned to not only understand the contextual information derived from user queries but also to accurately map this information to the appropriate action graph objective outputs. The re-training process involves adjusting the model's parameters to minimize the difference between the predicted outputs and the labeled outputs in the training data. Through iterative learning and fine-tuning, the first large language model becomes adept at generating the labeled action graph objective outputs based on the labeled contextual information. This enhanced model is then integrated into the first autonomous model, enabling it to autonomously process user queries, determine the contextual information, and produce the required action graph objective outputs with high accuracy. This process ensures that the autonomous model is well-equipped to handle real-world user queries and generate effective and relevant action graph outputs.

At step 404, process 400 (e.g., using one or more components described above) process the first action graph objective with a second autonomous model to generate a first action graph. For example, the system may process the first action graph objective with a second autonomous model to generate a first action graph, wherein the second autonomous model is trained using a second large language model to determine action graph outputs for inputted action graph objectives.

In some embodiments, the system trains the second autonomous model using the second large language model to determine the action graph outputs for the inputted action graph objectives by generating a second set of training data comprising labeled action graph objectives and labeled action graph outputs, retrieving the second large language model, wherein the second large language model is pre-trained to process the inputted user queries to determine the labeled inputted action graph objectives, and re-training the second large language model, using the second set of training data, to generate the labeled action graph objective outputs for the labeled action graph objectives.

For example, the system may train a second autonomous model using a second LLM to determine action graph outputs for inputted action graph objectives through a structured training process. To do so, the system generates a second set of training data that includes labeled action graph objectives paired with their corresponding labeled action graph outputs. This data set may provide the necessary examples for teaching the model how to translate action graph objectives into specific outputs. The system then retrieves the second large language model, which has been pre-trained to understand and process natural language input, particularly focusing on determining labeled inputted action graph objectives from user queries. This pre-training equips the model with a foundational understanding of language and contextual interpretation but requires further refinement to handle the specific task of generating action graph outputs. The system may re-train the pre-trained second large language model using the second set of training data. During this re-training phase, the model undergoes fine-tuning to learn how to map action graph objectives to their respective outputs accurately. This involves adjusting the model's parameters to reduce the discrepancies between its predictions and the labeled outputs provided in the training data.

Through iterative learning, where the model continually refines its understanding and predictions, the second large language model becomes proficient at generating action graph outputs based on the given objectives. This re-trained model is then integrated into the second autonomous model, enabling it to autonomously process action graph objectives and produce the corresponding action graph outputs with high precision. This comprehensive training approach ensures that the autonomous model is capable of effectively transforming specified objectives into actionable outputs, thereby enhancing the system's overall functionality and performance.

In some embodiments, training the second autonomous model using the second large language model to determine the action graph outputs for the inputted action graph objectives comprises generating training data for the second autonomous model based on the action graph objective outputs outputted by the first autonomous model and training the second autonomous model, using the training data, to generate inputs for the third autonomous model.

For example, the system may train a second autonomous model using a second LLM to determine action graph outputs for inputted action graph objectives through a systematic process involving multiple stages of data generation and model training. To do so, the system may generate training data for the second autonomous model based on the action graph objective outputs produced by the first autonomous model. This involves leveraging the outputs of the first autonomous model, which has been trained to interpret user queries and determine contextual information to generate action graph objectives.

Once the first autonomous model produces these action graph objective outputs, the system compiles this data, pairing each action graph objective with its corresponding action graph output. This dataset forms the foundation for training the second autonomous model, ensuring that it learns to accurately generate the necessary outputs based on the objectives. The system then retrieves the second large language model, which is pre-trained to understand and process natural language. This pre-training gives the model a strong foundation in language comprehension but does not yet equip it to handle the specific task of generating action graph outputs from objectives. To bridge this gap, the system undertakes a re-training process. Using the compiled training data, the system re-trains the second large language model. During this re-training phase, the model is fine-tuned to learn how to transform action graph objectives into specific action graph outputs. This involves iterative adjustments to the model's parameters to minimize errors between its predictions and the provided labeled outputs in the training data. Through this re-training, the second large language model becomes adept at generating accurate action graph outputs based on the given objectives. These outputs are then designed to serve as inputs for a third autonomous model. The second autonomous model, now fine-tuned, can autonomously process the action graph objectives and produce outputs that are precisely formatted and structured to be used by the third autonomous model. This multi-stage training process ensures a seamless and efficient flow of information through the system, where each autonomous model builds upon the outputs of the previous one, ultimately leading to robust and accurate processing of complex tasks.

At step 406, process 400 (e.g., using one or more components described above) process the first action graph with a third autonomous model to generate a first validated action graph. For example, the system may process the first action graph with a third autonomous model to generate a first validated action graph, wherein the third autonomous model is trained using a third large language model to validate inputted action graphs.

In some embodiments, the system may train the third autonomous model using the third large language model to validate the inputted action graphs by generating a third set of training data comprising labeled action graph characteristics and labeled action graph outputs, retrieving the third large language model, wherein the third large language model is pre-trained to generate code script to modify action graph characteristics, and re-training the third large language model, using the third set of training data, to generate code script modifications to results in the labeled action graph outputs by modifying the labeled action graph characteristics.

For example, the system may train a third autonomous model using a third (LLM to validate inputted action graphs through a structured training process that involves data generation, model retrieval, and re-training. To do so, the system may generate a third set of training data comprising labeled action graph characteristics and corresponding labeled action graph outputs. This dataset is essential for teaching the model how specific characteristics of action graphs influence their outputs and how to modify these characteristics to achieve desired results. The system then retrieves the third large language model, which has been pre-trained to generate code scripts that can modify action graph characteristics. This pre-training equips the model with a foundational understanding of code generation and the structural elements of action graphs, but it requires further refinement to handle the specific task of validating and modifying action graphs based on their characteristics.

To refine the model, the system re-trains the pre-trained third large language model using the third set of training data. During this re-training phase, the model learns to generate precise code scripts that can modify action graph characteristics to produce specific labeled outputs. The training process involves presenting the model with various action graph characteristics and their corresponding desired outputs, allowing it to learn the relationships between these elements and how to effectively alter the graphs through code. As the model undergoes iterative adjustments, it becomes proficient in generating code script modifications that result in the labeled action graph outputs by altering the labeled action graph characteristics. This re-training ensures that the model can accurately validate and modify action graphs, ensuring they meet the required specifications and objectives. Once re-trained, the third large language model is integrated into the third autonomous model, enabling it to autonomously validate inputted action graphs. The model can now analyze the characteristics of these graphs, generate the necessary code scripts to modify them, and ensure that the modifications lead to the desired outputs. This comprehensive training approach ensures that the third autonomous model can effectively validate and optimize action graphs, enhancing the system's overall capability to manage and improve complex action graph structures.

In some embodiments, the system may train the third autonomous model using the third large language model to validate the inputted action graphs by generating training data for the third autonomous model based on the action graph outputs outputted by the second autonomous model and training the third autonomous model, using the training data, to validate inputs to the third autonomous model. For example, the system may train a third autonomous model using a third LLM to validate inputted action graphs through a structured process involving data generation and model training. To do so, the system generates training data for the third autonomous model based on the action graph outputs produced by the second autonomous model. This data includes various action graph outputs, each annotated with validation criteria and expected results, providing a comprehensive dataset for training the validation model. The system then retrieves the third large language model, which has been pre-trained to understand and generate code scripts related to action graph characteristics. This pre-training provides the model with a foundational understanding of the structure and function of action graphs, as well as the ability to generate code modifications. However, to tailor the model specifically for validation tasks, further re-training is required.

Using the training data generated from the second autonomous model's outputs, the system re-trains the third large language model. During this re-training phase, the model is fine-tuned to learn how to validate action graphs by assessing their outputs against predefined validation criteria. The process involves presenting the model with various examples of action graph outputs and their associated validation requirements, enabling it to learn the patterns and rules necessary for effective validation. As the model iterates through the training data, it learns to accurately identify discrepancies, validate the correctness of the action graph outputs, and suggest necessary adjustments to meet the validation criteria. This training process ensures that the model becomes proficient in validating inputs by cross-referencing them with the expected outcomes and validation standards. Once the re-training is complete, the third large language model is integrated into the third autonomous model, equipping it to autonomously validate inputted action graphs. The model can now analyze the outputs generated by the second autonomous model, check them against the validation criteria, and ensure that they meet the required standards. This comprehensive training approach ensures that the third autonomous model can effectively validate and verify action graph outputs, enhancing the system's overall reliability and accuracy in managing complex action graph structures.

At step 408, process 400 (e.g., using one or more components described above) generate a first response to the first user query. For example, the system may generate for display, in the user interface, a first response to the first user query based on the first validated action graph.

In some embodiments, the system may process, using a first model, a plurality of user queries to generate respective action graph objectives, wherein the respective action graph objectives are processed to generate respective action graphs, and wherein the respective action graphs are processed to generate respective validated action graphs. The system may generate respective responses to the plurality of user queries based on the respective validated action graphs. The system may iteratively receive, by the first model, respective feedback based on the respective responses. The system may iteratively update, the first model, based on the respective feedback.

For example, the system may update a model through an iterative learning process that incorporates user interactions and feedback to improve its accuracy and effectiveness over time. Initially, the system processes a plurality of user queries using a first model to generate corresponding action graph objectives, which are then transformed into respective action graphs. These action graphs undergo validation to ensure they align with expected outcomes, producing validated action graphs that serve as the foundation for generating responses to user queries. As the system delivers these responses, it continuously collects feedback regarding their effectiveness, relevance, and accuracy. This feedback, which may be derived from explicit user ratings, implicit behavioral signals, or automated evaluation mechanisms, is iteratively fed back into the first model. By analyzing the patterns in this feedback, the system identifies areas for improvement, such as refining decision-making rules, adjusting weighting factors, or retraining underlying models to enhance their predictive accuracy. The model is then updated based on these insights, ensuring that future iterations of action graph generation and response formulation become increasingly optimized. This iterative feedback loop enables the system to dynamically adapt and evolve, improving its ability to generate precise, contextually relevant, and high-quality responses to user queries.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

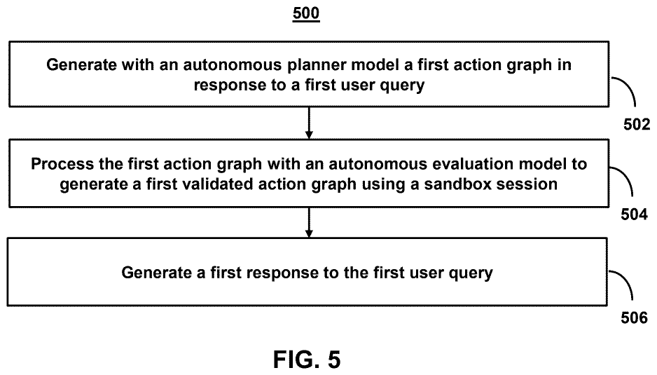

FIG. 5 shows a flowchart of the steps involved in validating action graphs using multi-autonomous model architectures, in accordance with one or more embodiments. For example, the system may use process 500 (e.g., as implemented on one or more system components described above) in order to generate complex responses to user queries received via a user interfaces. For example, in some embodiments, process 500 may be performed by evaluator model 200 (FIG. 2A) to generate user queries and/or responses as shown in FIG. 2C and FIG. 2D.

At step 502, process 500 (e.g., using one or more components described above) generate with an autonomous planner model a first action graph in response to a first user query. For example, the system may receive, at a user interface, a first user query from a first user, wherein the first user query indicates an initial state and a requested final state. The system may, in response to the first user query, generate with an autonomous planner model, of a multi-autonomous model architecture, a first action graph, wherein the first action graph comprises a plurality of nodes and a plurality of edges from the initial state and the requested final state.

In some embodiments, receiving first user query further comprises the system processing the first user query with an understanding model to generate a first action graph objective, wherein the understanding model is trained using a first large language model to determine contextual information in order to determine action graph objective outputs for inputted user queries. For example, the system may process a first user query with an understanding model to generate a first action graph objective through a series of advanced language processing steps. The understanding model may be trained using a first LLM, which has been fine-tuned to determine contextual information and translate that into specific action graph objective outputs based on user queries. For example, when a user submits the first query, the system inputs this query into the understanding model. The understanding model leverages the capabilities of the first LLM, which has been pre-trained on vast amounts of text data and further refined using specialized training data that includes examples of user queries paired with their corresponding contextual information and action graph objectives. The first large language model may analyze the user query to extract relevant contextual information. This involves understanding the semantics, syntax, and intent behind the query. The model identifies key elements and concepts within the query, such as user requirements, constraints, and desired outcomes. It uses this contextual understanding to frame the problem and identify the objectives that need to be achieved. Based on this analysis, the understanding model generates a first action graph objective. This objective represents a formalized goal or set of goals that the action graph needs to accomplish, structured in a way that can be further processed by subsequent models or systems within the architecture. The action graph objective output is tailored to reflect the specific needs and intentions expressed in the user query, ensuring that the system's response is both relevant and actionable. Through this process, the understanding model effectively transforms the user's natural language query into a precise, structured action graph objective. This allows the system to proceed with creating, testing, and validating action graphs that are aligned with the user's goals, ultimately facilitating more accurate and efficient decision-making and task execution.

At step 504, process 500 (e.g., using one or more components described above) process the first action graph with an autonomous evaluation model to generate a first validated action graph using a sandbox session. For example, the system may process the first action graph with an autonomous evaluation model to generate a first validated action graph by generating a sandbox session for the first action graph, retrieving a user profile for the user, populating the sandbox session with the user profile data from the user profile, and testing the first action graph in the sandbox session to determine whether the first action graph results in the requested final state.

For example, the system processes the first action graph with an autonomous evaluation model to generate a first validated action graph through a series of steps designed to ensure the accuracy and effectiveness of the action graph. To do so, the system generates a sandbox session for the first action graph. This sandbox environment is an isolated, controlled setting that allows for comprehensive testing and evaluation of the action graph without affecting the live system. The system may retrieve the user profile associated with the user who submitted the action graph. The user profile contains relevant data, such as user preferences, historical behavior, and specific requirements. This data is crucial for tailoring the evaluation process to the user's unique context and needs. The sandbox session is then populated with the user profile data. By incorporating this personalized information, the system ensures that the evaluation process considers the user's specific circumstances and preferences. This step is essential for accurately testing the action graph's relevance and effectiveness for the user. Once the sandbox session is prepared, the system tests the first action graph within this environment. The autonomous evaluation model simulates the execution of the action graph, closely monitoring its performance to determine whether it successfully achieves the requested final state. This testing involves running through the various nodes and edges defined in the action graph, checking for logical consistency, efficiency, and the ability to meet the specified objectives. By testing the action graph in the sandbox session, the system can identify any issues, inefficiencies, or errors that may prevent the action graph from reaching the desired final state. If the action graph performs as expected and results in the requested final state, it is considered validated. The system then generates a first validated action graph, ready for implementation or further use. This rigorous process ensures that the action graph is both effective and tailored to the user's needs, enhancing the reliability and performance of the system.

In some embodiments, the system may generate the sandbox session for the first action graph by determining a first simulation level for an external system, wherein the first simulation level indicates a level at which dependencies to the external system is simulated, comparing the first simulation level to a threshold simulation level, wherein the threshold simulation level is based on access to external systems, databases, or services of an actual production environment, determining that the first simulation level exceeds the threshold simulation level, and determining to generate the sandbox session based on the first simulation level exceeding the threshold simulation level.

For example, the system generates a sandbox session for the first action graph by first determining a suitable simulation level for an external system. This simulation level, known as the first simulation level, indicates the extent to which dependencies on the external system will be simulated during the sandbox session. It encompasses various factors such as the complexity of interactions, the fidelity of the simulation, and the inclusion of external databases or services. To ensure the simulation is appropriate and realistic, the system compares the first simulation level to a predefined threshold simulation level. The threshold simulation level is established based on the degree of access to external systems, databases, or services that are available in the actual production environment. This threshold ensures that the simulation provides a close approximation to real-world conditions without compromising security or performance. The system then assesses whether the first simulation level exceeds the threshold simulation level. If it does, this indicates that the proposed simulation will incorporate a higher level of detail and interaction with external dependencies than is typical for a standard sandbox environment. Recognizing the importance of accurate and thorough testing, the system determines that a sandbox session should be generated based on the fact that the first simulation level exceeds the threshold simulation level. By generating the sandbox session under these conditions, the system ensures that the first action graph is tested in an environment that closely mirrors the actual production environment. This high-fidelity simulation allows for comprehensive evaluation of the action graph's performance, interactions, and potential issues, providing valuable insights and validation before deployment in the live system.

In some embodiments, the system may generate the sandbox session for the first action graph by determining a first resource allocation for the autonomous evaluation model, wherein the first resource allocation indicates an amount of resources allocated to the autonomous evaluation model to generate the sandbox session, comparing the first resource allocation to a threshold resource allocation, wherein the threshold resource allocation is based on resources allocated to an actual production environment, determining that the first resource allocation exceeds the threshold resource allocation, and determining to generate the sandbox session based on the first resource allocation exceeding the threshold resource allocation.

For example, the system may generate a sandbox session for the first action graph by determining an appropriate resource allocation for the autonomous evaluation model. This involves calculating a first resource allocation, which specifies the amount of computational resources, memory, and processing power allocated to the evaluation model to effectively create and manage the sandbox session. The first resource allocation ensures that the evaluation model has sufficient capacity to simulate the action graph's operations comprehensively. To validate this allocation, the system compares the first resource allocation to a predefined threshold resource allocation. The threshold resource allocation is determined based on the typical resources allocated to the evaluation processes in an actual production environment. This comparison ensures that the sandbox session will be realistic and capable of accurately reflecting the conditions and constraints of the production environment. If the system determines that the first resource allocation exceeds the threshold resource allocation, it recognizes that the sandbox session will have more than adequate resources to perform a thorough evaluation of the action graph. This surplus in resources allows for an in-depth simulation, covering various scenarios and edge cases that might not be feasible with limited resources. Upon confirming that the first resource allocation exceeds the threshold resource allocation, the system decides to generate the sandbox session. This decision ensures that the sandbox environment is not only robust and comprehensive but also capable of handling the complexity of the first action graph. The adequate resource allocation facilitates detailed testing, performance monitoring, and validation of the action graph, ensuring that it functions as expected and meets the desired objectives before being deployed in the actual production environment.

In some embodiments, the system may generate the sandbox session for the first action graph by determining a first performance metric for the autonomous evaluation model, wherein the first performance metric indicates a performance of the autonomous evaluation model in the sandbox session, comparing the first performance metric to a threshold performance metric, wherein the threshold performance metric corresponds to a performance of an actual production environment, determining that the first performance metric exceeds the threshold performance metric, and determining to generate the sandbox session based on the first performance metric exceeding the threshold performance metric. For example, the system may generate a sandbox session for the first action graph by first determining a key performance metric for the autonomous evaluation model. This performance metric, referred to as the first performance metric, measures the model's efficiency, accuracy, and overall capability to simulate and evaluate the action graph within the sandbox environment. The first performance metric is crucial as it provides a quantitative assessment of how well the evaluation model functions under the given resource allocation.

To ensure that the sandbox session is realistic and reliable, the system compares the first performance metric to a predefined threshold performance metric. This threshold performance metric corresponds to the expected performance standards in an actual production environment, serving as a benchmark for acceptable performance levels. The system then evaluates whether the first performance metric meets or exceeds the threshold performance metric. If the first performance metric surpasses the threshold, it indicates that the autonomous evaluation model is performing at or above the required standards, ensuring that the sandbox session will provide accurate and meaningful results. Upon confirming that the first performance metric exceeds the threshold performance metric, the system decides to generate the sandbox session. This decision ensures that the sandbox environment is both performant and well-resourced, allowing the autonomous evaluation model to thoroughly test and validate the first action graph. This comprehensive approach ensures that the action graph is robust, reliable, and ready for deployment in the actual production environment.

In some embodiments, the system may generate the sandbox session for the first action graph by detecting whether a first database is available to the sandbox session and determining to generate the sandbox session based on the first database being available. For example, the system may generate a sandbox session for the first action graph by first detecting the availability of a critical resource, specifically the first database. This database is essential as it contains the necessary data for simulating and evaluating the action graph accurately. The system initiates this process by querying the infrastructure to check if the first database is accessible and can be integrated into the sandbox environment. Upon confirming the availability of the first database, the system assesses whether it can reliably access and utilize this database within the sandbox session. This involves verifying connection parameters, ensuring data integrity, and confirming that the database is up-to-date and reflective of the data conditions expected in the actual production environment.

Once the system verifies that the first database is available and ready for use, it proceeds to determine the feasibility of generating the sandbox session. The availability of the first database is a crucial criterion, as it ensures that the sandbox session will have the necessary data support to accurately simulate the action graph's operations and interactions. With the first database confirmed as available, the system decides to generate the sandbox session. This decision is based on the premise that having access to the first database will enable a thorough and realistic evaluation of the action graph. The sandbox session is then configured to incorporate the database, ensuring that all simulations and tests performed within this environment are data-driven and reflective of real-world scenarios. This process ensures that the sandbox session is not only functional but also equipped with the necessary resources to validate the action graph effectively, providing a robust platform for testing before deployment in the production environment.

In some embodiments, the system may test the first action graph in the sandbox session to determine whether the first action graph results in the requested final state by determining an initial final state based on the first action graph, comparing the initial final state to the requested final state, and generating the first validated action graph based on comparing the initial final state to the requested final state. For example, the system may test the first action graph in the sandbox session to determine whether it results in the requested final state through a systematic evaluation process. To do so, the system may run the first action graph within the sandbox environment, which simulates its operations and transitions. During this simulation, the system monitors the progression of states defined by the action graph, ultimately determining an initial final state. This initial final state represents the end condition achieved by following the sequence of actions and transitions outlined in the action graph. Once the initial final state is determined, the system compares it to the requested final state specified by the user or application requirements. This comparison involves checking for consistency between the expected outcomes and the actual results produced by the action graph. The system evaluates various aspects such as data values, system statuses, and operational conditions to ensure they align with the requested final state.

If the initial final state matches the requested final state, it indicates that the first action graph has successfully achieved the desired outcome. Based on this successful comparison, the system generates the first validated action graph. This validated action graph is essentially the original action graph, now confirmed to meet the specified requirements and ready for deployment or further use. However, if discrepancies are found between the initial final state and the requested final state, the system identifies the areas of deviation. This feedback can be used to modify and refine the action graph to better align with the desired outcomes. Through this thorough testing and validation process, the system ensures that the action graph is both effective and reliable, capable of achieving the intended final state before it is deployed in the actual production environment.

At step 506, process 500 (e.g., using one or more components described above) generate a first response to the first user query. For example, the system may generate for display, in the user interface, a first response to the first user query based on the first validated action graph. For example, the system may generate for display, in a user interface, a first response to the first user query based on the first validated action graph through a structured sequence of steps. Initially, after the first action graph is tested and validated in the sandbox session, ensuring it achieves the requested final state, the system prepares to create a user-friendly response. The system begins by extracting key information from the first validated action graph. This includes the sequence of actions, decision points, and outcomes that were validated as part of the graph. It translates these technical details into a comprehensible format that aligns with the user's original query and expected results. Next, the system constructs the first response by summarizing the validated action graph's results. This summary includes the main objectives achieved, any significant steps taken, and the final state reached. The response is tailored to be clear and informative, highlighting how the action graph meets the user's requirements and addressing any specific points raised in the query. The system then formats this information for display in the user interface. It ensures the response is presented in a visually accessible manner, using appropriate layout elements such as headings, bullet points, and sections to enhance readability. Interactive elements like hyperlinks or expandable sections may be included to provide additional details or related information. Finally, the system generates the first response in the user interface, integrating it seamlessly into the existing design. This response provides the user with a comprehensive overview of how their query was processed and resolved through the action graph, offering transparency and clarity on the system's operations. By presenting the validated action graph's outcomes in an understandable and user-friendly format, the system ensures effective communication and enhances the overall user experience.

In some embodiments, the system may determine whether to update a first action graph based on testing conducted in a sandbox session by analyzing the test feedback generated from the session. This feedback may include performance metrics, error reports, success rates, or other qualitative and quantitative indicators that assess the effectiveness of the first action graph in executing predefined tasks. The system utilizes this feedback to refine an autonomous evaluation model, which is responsible for assessing the action graph's efficacy and adaptability. If the test feedback indicates suboptimal performance, such as inefficiencies, errors, or failure to achieve expected outcomes, the system may modify the first action graph to improve its decision-making logic, execution paths, or response mechanisms. The autonomous evaluation model plays a crucial role in this process by learning from the test feedback, identifying patterns in failures or inefficiencies, and informing the system about necessary adjustments. This iterative approach ensures continuous refinement and optimization of the action graph, allowing the system to enhance its capabilities over time and adapt to evolving conditions or requirements.

It is contemplated that the steps or descriptions of FIG. 5 may be used with any other embodiment of this disclosure. In addition, the steps and descriptions described in relation to FIG. 5 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 5.

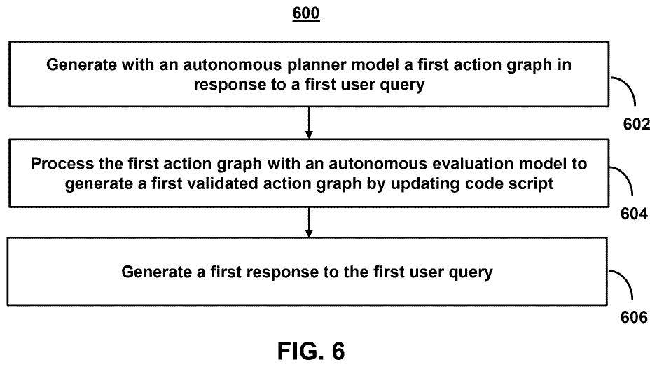

FIG. 6 shows a flowchart of the steps involved in updating code script in validated action graphs using multi-autonomous model architectures, in accordance with one or more embodiments. For example, the system may use process 400 (e.g., as implemented on one or more system components described above) in order to generate complex responses to user queries received via a user interfaces. For example, in some embodiments, process 500 may be performed by evaluator model 200 (FIG. 2A) to update code scripts as shown in FIG. 2B and FIG. 2D.

At step 602, process 600 (e.g., using one or more components described above) generate with an autonomous planner model a first action graph in response to a first user query. For example, the system may receive, at a user interface, a first user query, wherein the first user query indicates an initial state and a requested final state. The system may then, in response to a first user query, generate with an autonomous planner model a first action graph, wherein the first user query indicates an initial state and a requested final state, wherein the first action graph comprises a plurality of nodes and a plurality of edges from the initial state and the requested final state, and wherein the plurality of nodes and the plurality of edges from the initial state and the requested final state are represented by first code script.

In some embodiments, receiving first user query further comprises the system processing the first user query with an understanding model to generate a first action graph objective, wherein the understanding model is trained using a first large language model to determine contextual information in order to determine action graph objective outputs for inputted user queries. For example, the system may process a first user query with an understanding model to generate a first action graph objective through a series of advanced language processing steps. The understanding model may be trained using a first LLM, which has been fine-tuned to determine contextual information and translate that into specific action graph objective outputs based on user queries. For example, when a user submits the first query, the system inputs this query into the understanding model. The understanding model leverages the capabilities of the first LLM, which has been pre-trained on vast amounts of text data and further refined using specialized training data that includes examples of user queries paired with their corresponding contextual information and action graph objectives. The first large language model may analyze the user query to extract relevant contextual information. This involves understanding the semantics, syntax, and intent behind the query. The model identifies key elements and concepts within the query, such as user requirements, constraints, and desired outcomes. It uses this contextual understanding to frame the problem and identify the objectives that need to be achieved. Based on this analysis, the understanding model generates a first action graph objective. This objective represents a formalized goal or set of goals that the action graph needs to accomplish, structured in a way that can be further processed by subsequent models or systems within the architecture. The action graph objective output is tailored to reflect the specific needs and intentions expressed in the user query, ensuring that the system's response is both relevant and actionable. Through this process, the understanding model effectively transforms the user's natural language query into a precise, structured action graph objective. This allows the system to proceed with creating, testing, and validating action graphs that are aligned with the user's goals, ultimately facilitating more accurate and efficient decision-making and task execution.

At step 604, process 600 (e.g., using one or more components described above) process the first action graph with an autonomous evaluation model to generate a first validated action graph by updating code script. For example, the system may process the first action graph with an autonomous evaluation model to generate a first validated action graph by determining a first update to the first action graph required to generate the first validated action graph, processing the first update using a large language model to generate a second code script corresponding to the first update, and updating first code script with the second code script.

For example, the system may process a first action graph with an autonomous evaluation model to generate a first validated action graph through a detailed and iterative updating process. To do so, the system runs the first action graph within the autonomous evaluation model, which simulates its operations to identify any discrepancies or inefficiencies that prevent it from achieving the desired final state. During this evaluation, the system determines that a first update is required to rectify these issues and generate a validated action graph. To implement the first update, the system leverages a LLM. The LLM is tasked with processing the necessary changes by generating a second code script that corresponds to the required update. This involves inputting the identified issues and desired modifications into the LLM, which then uses its advanced language processing capabilities to create precise and effective code adjustments. The second code script encapsulates these changes in a format that can be seamlessly integrated into the existing action graph structure. Once the second code script is generated, the system proceeds to update the first code script with these new modifications. This integration step involves carefully merging the second code script into the existing code base, ensuring that the updates are correctly applied without introducing new errors or inconsistencies. The system verifies that the second code script accurately addresses the identified issues and enhances the action graph's functionality as intended. After the update is applied, the system re-evaluates the modified action graph within the autonomous evaluation model. This iterative process may be repeated as necessary to refine the action graph further until it meets all the specified criteria and achieves the requested final state. Upon successful validation, the updated and improved action graph is designated as the first validated action graph, ready for deployment or further use. This thorough approach ensures that the action graph is optimized, reliable, and fully aligned with the desired outcomes.

In some embodiments, the system may determine the first update to the first action graph required to generate the first validated action graph by determining an initial final state based on the first action graph, comparing the initial final state to the requested final state, and generating the first validated action graph based on comparing the initial final state to the requested final state. For example, the system may execute the first action graph within a simulation environment to observe its operations and outcomes, resulting in an initial final state. This initial final state is the end condition achieved by the sequence of actions and transitions outlined in the first action graph. The system then compares this initial final state to the requested final state specified by the user or application requirements. This comparison involves a detailed analysis to identify any discrepancies between the two states. The system evaluates various factors such as the accuracy of data values, the correctness of system statuses, and the fulfillment of operational conditions. By identifying these gaps, the system determines the specific areas where the first action graph falls short of achieving the desired outcome. Based on this comparison, the system identifies necessary modifications to the first action graph. These modifications, or updates, are designed to address the identified discrepancies and align the initial final state with the requested final state. The system outlines these updates in detail, specifying the changes needed in the sequence of actions, decision points, or transitions within the action graph. To implement these updates, the system uses a large language model to generate a second code script that encapsulates the required modifications. This new script is then integrated into the original action graph, creating an updated version that incorporates the changes designed to achieve the desired final state. After applying the second code script, the system re-evaluates the modified action graph to ensure it now meets the specified criteria and achieves the requested final state. This iterative process of comparison and updating continues until the action graph is fully validated.

In some embodiments, the system determines a difference between the initial final state and the requested final state and determines an action graph characteristic corresponding to the difference to determine the first update. The system performs a thorough comparison between the initial final state and the requested final state. This involves analyzing various attributes and outcomes of both states, such as data values, system statuses, operational conditions, and any specific criteria or benchmarks set forth by the user. Through this analysis, the system identifies discrepancies or differences between the two states. These differences highlight where the initial final state falls short in meeting the desired objectives.

Once the differences are identified, the system proceeds to determine the specific action graph characteristics that correspond to these differences. Action graph characteristics can include the sequence of actions, decision points, conditions for transitions, and the logic governing the flow of operations within the graph. By examining the nature of each identified difference, the system pinpoints which characteristics of the action graph need to be modified to align the initial final state with the requested final state. For example, if the initial final state fails to achieve a particular data value that is present in the requested final state, the system might identify that a specific action or decision point in the action graph needs to be updated to incorporate additional data processing or validation steps. Similarly, if the system status in the initial final state does not match the requested final state, the system may determine that the conditions for certain transitions need to be adjusted. After identifying the necessary action graph characteristics that correspond to the differences, the system formulates the first update. This update is designed to modify the relevant characteristics within the action graph, ensuring that the updated graph will produce an outcome that matches the requested final state.

In some embodiments, the system determines an action graph characteristic corresponding to the first update and inputs the action graph characteristic into the large language model to generate code script implementing the action graph characteristic. For example, the system may determine an action graph characteristic corresponding to the first update by first identifying the specific elements within the action graph that need modification. This is done after comparing the initial final state with the requested final state and pinpointing the discrepancies. These discrepancies reveal which parts of the action graph—such as the sequence of actions, decision points, or transition conditions—require changes to meet the desired outcomes. Once the necessary action graph characteristic is identified, the system formulates a precise description of the required update. This description includes detailed information about the modifications needed, such as adding new actions, altering decision logic, or adjusting transition criteria. The description is structured in a way that the LLM can effectively process and understand. The system then inputs this detailed description of the action graph characteristic into the large language model. The LLM, pre-trained on vast amounts of text data and further fine-tuned for code generation tasks, interprets the input and generates the corresponding code script. This code script is designed to implement the specified modifications within the action graph. For example, if the update requires adding a validation step to ensure data integrity at a particular decision point, the input to the LLM might describe the new validation criteria and where it should be applied in the action graph. The LLM then generates the necessary code that introduces this validation step into the existing code base of the action graph. After generating the code script, the system integrates this new code into the original action graph. This integration involves updating the relevant sections of the action graph's code base with the newly generated script, ensuring that the modifications are applied correctly and consistently.

In some embodiments, the system may update the first code script with the second code script by determining a location in the first code script for inserting the second code script and inserting the second code script at the location. For example, the system may analyze the structure and flow of the first code script to determine the most appropriate location for inserting the second code script. This involves understanding the logic, dependencies, and sequence of operations within the first code script. To identify the precise location, the system evaluates where the updates specified by the second code script should logically occur within the existing code. This may involve pinpointing specific functions, methods, or sections of the code that are relevant to the updates. The system looks for markers or keywords in the first code script that correspond to the areas needing modification or enhancement. Once the ideal insertion point is identified, the system proceeds to integrate the second code script into the first code script. This involves placing the new code at the determined location in a manner that maintains the coherence and functionality of the overall script. The system ensures that the insertion does not disrupt the existing logic or introduce errors. The insertion process requires careful handling to ensure that the syntax and formatting of both the first and second code scripts are compatible. The system checks for any conflicts or redundancies that might arise from the integration and resolves them to maintain smooth operation. Additionally, it may update or add necessary references, import statements, or dependencies to support the new code. After the second code script is inserted at the appropriate location, the system conducts a series of tests to validate the changes. These tests verify that the updated code functions as intended and integrates seamlessly with the existing code base. Any issues identified during testing are addressed promptly to ensure the overall stability and performance of the code.

At step 606, process 600 (e.g., using one or more components described above) generate a first response to the first user query. For example, the system may generate a first response to the first user query based on the first validated action graph. For example, the system may generate for display, in a user interface, a first response to the first user query based on the first validated action graph through a structured sequence of steps. Initially, after the first action graph is tested and validated in the sandbox session, ensuring it achieves the requested final state, the system prepares to create a user-friendly response. The system begins by extracting key information from the first validated action graph. This includes the sequence of actions, decision points, and outcomes that were validated as part of the graph. It translates these technical details into a comprehensible format that aligns with the user's original query and expected results. Next, the system constructs the first response by summarizing the validated action graph's results. This summary includes the main objectives achieved, any significant steps taken, and the final state reached. The response is tailored to be clear and informative, highlighting how the action graph meets the user's requirements and addressing any specific points raised in the query. The system then formats this information for display in the user interface. It ensures the response is presented in a visually accessible manner, using appropriate layout elements such as headings, bullet points, and sections to enhance readability. Interactive elements like hyperlinks or expandable sections may be included to provide additional details or related information. Finally, the system generates the first response in the user interface, integrating it seamlessly into the existing design. This response provides the user with a comprehensive overview of how their query was processed and resolved through the action graph, offering transparency and clarity on the system's operations. By presenting the validated action graph's outcomes in an understandable and user-friendly format, the system ensures effective communication and enhances the overall user experience.

In some embodiments, the system generates the first response to the first user query based on the first validated action graph by generating with the autonomous planner model the first validated action graph using the second code script and processing the first validated action graph with the autonomous evaluation model. For example, the system may generate a first response to the first user query based on the first validated action graph through a comprehensive process involving both the autonomous planner model and the autonomous evaluation model. Initially, the system identifies necessary updates to the first action graph, leading to the creation of a second code script that incorporates these updates. Using the autonomous planner model, the system generates the first validated action graph by integrating the second code script into the original action graph. The autonomous planner model ensures that the integration is seamless, updating the action graph with the new code while maintaining its structural integrity and logical coherence. Once the first validated action graph is generated, the system processes it using the autonomous evaluation model. This model rigorously tests the updated action graph within a controlled simulation environment, verifying that it meets all specified criteria and achieves the desired final state. The evaluation model simulates the execution of the action graph, checking for errors, inefficiencies, and ensuring that the graph performs as intended in various scenarios. After successful validation by the evaluation model, the system confirms that the first validated action graph accurately resolves the user's query. The next step is to generate a comprehensive and user-friendly response based on this validated action graph. The system constructs the first response by summarizing the outcomes and key actions of the validated action graph. It translates technical details into a clear and informative narrative that aligns with the user's original query. This summary includes the objectives achieved, the significant steps taken, and the final state reached by the action graph.

It is contemplated that the steps or descriptions of FIG. 6 may be used with any other embodiment of this disclosure. In addition, the steps and descriptions described in relation to FIG. 6 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 6.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for generating complex responses to user queries.
2. A method for using multi-autonomous model architectures.
3. The method of any one of the preceding embodiments, further comprising: processing, using one or more autonomous models, a first user query to generate a first action graph objective using a first large language model to determine contextual information in order to determine action graph objective outputs for inputted user queries, wherein the first action graph objective is processed to generate a first action graph, and wherein the first action graph is processed to generate a first validated action graph; and generating a first response to the first user query based on the first validated action graph.
4. The method of any one of the preceding embodiments, further comprising: processing a first action graph with an autonomous evaluation model to generate a first validated action graph by: generating a sandbox session for the first action graph; retrieving a user profile for a user; populating the sandbox session with user profile data from the user profile; and testing the first action graph in the sandbox session to determine whether the first action graph results in a requested final state; and generating a first response to the first user query based on the first validated action graph.
5. The method of any one of the preceding embodiments, further comprising: processing a first action graph with an autonomous evaluation model to generate a first validated action graph by: determining a first update to the first action graph required to generate the first validated action graph; processing the first update using a large language model to generate a second code script corresponding to the first update; and updating first code script with the second code script; and generating a first response to the first user query based on the first validated action graph.
6. The method of any one of the preceding embodiments, further comprising: processing a first user query with a first autonomous model to generate a first action graph objective, wherein the first autonomous model is trained using a first large language model to determine contextual information in order to determine action graph objective outputs for inputted user queries; processing the first action graph objective with a second autonomous model to generate a first action graph, wherein the second autonomous model is trained using a second large language model to determine action graph outputs for inputted action graph objectives; processing the first action graph with a third autonomous model to generate a first validated action graph, wherein the third autonomous model is trained using a third large language model to validate inputted action graphs; and generating a first response to the first user query based on the first validated action graph.
7. The method of any one of the preceding embodiments, further comprising: in response to a first user query, generating with an autonomous planner model a first action graph, wherein the first action graph comprises a plurality of nodes and a plurality of edges from the initial state and the requested final state, wherein the first user query indicates an initial state and a requested final state; processing the first action graph with an autonomous evaluation model to generate a first validated action graph by: generating a sandbox session for the first action graph; retrieving a user profile for the user; populating the sandbox session with the user profile data from the user profile; and testing the first action graph in the sandbox session to determine whether the first action graph results in the requested final state; and generating a first response to the first user query based on the first validated action graph.
8. The method of any one of the preceding embodiments, further comprising: in response to a first user query, generating with an autonomous planner model a first action graph, wherein the first user query indicates an initial state and a requested final state, wherein the first action graph comprises a plurality of nodes and a plurality of edges from the initial state and the requested final state, and wherein the plurality of nodes and the plurality of edges from the initial state and the requested final state are represented by first code script; processing the first action graph with an autonomous evaluation model to generate a first validated action graph by: determining a first update to the first action graph required to generate the first validated action graph; processing the first update using a large language model to generate a second code script corresponding to the first update; and updating first code script with the second code script; and generating a first response to the first user query based on the first validated action graph.
9. The method of any one of the preceding embodiments, further comprising: receiving, at a user interface, a first user query, wherein the first user query indicates an initial state and a requested final state; and generating for display, in the user interface, a first response to the first user query based on the first validated action graph.
10. The method of any one of the preceding embodiments, wherein training the first autonomous model using the first large language model to determine the contextual information in order to determine the action graph objective outputs for the inputted user queries further comprises: generating a first set of training data for the contextual information comprising labeled action graph objective outputs for labeled contextual information; retrieving the first large language model, wherein the first large language model is pre-trained to process the inputted user queries to determine the labeled contextual information; and re-training the first large language model, using the first set of training data, to generate the labeled action graph objective outputs for the labeled contextual information.
11. The method of any one of the preceding embodiments, wherein training the second autonomous model using the second large language model to determine the action graph outputs for the inputted action graph objectives further comprises: generating a second set of training data comprising labeled action graph objectives and labeled action graph outputs; retrieving the second large language model, wherein the second large language model is pre-trained to process the inputted user queries to determine the labeled inputted action graph objectives; and re-training the second large language model, using the second set of training data, to generate the labeled action graph objective outputs for the labeled action graph objectives.
12. The method of any one of the preceding embodiments, wherein training the third autonomous model using the third large language model to validate the inputted action graphs further comprises: generating a third set of training data comprising labeled action graph characteristics and labeled action graph outputs; retrieving the third large language model, wherein the third large language model is pre-trained to generate code script to modify action graph characteristics; and re-training the third large language model, using the third set of training data, to generate code script modifications to results in the labeled action graph outputs by modifying the labeled action graph characteristics.
13. The method of any one of the preceding embodiments, wherein training the second autonomous model using the second large language model to determine the action graph outputs for the inputted action graph objectives further comprises: generating training data for the second autonomous model based on the action graph objective outputs outputted by the first autonomous model; and training the second autonomous model, using the training data, to generate inputs for the third autonomous model.
14. The method of any one of the preceding embodiments, wherein training the third autonomous model using the third large language model to validate the inputted action graphs further comprises: generating training data for the third autonomous model based on the action graph outputs outputted by the second autonomous model; and training the third autonomous model, using the training data, to validate inputs to the third autonomous model.
15. The method of any one of the preceding embodiments, wherein processing the first action graph with the third autonomous model to generate the first validated action graph further comprises: determining a first update to the first action graph required to generate the first validated action graph; processing the first update using a large language model to generate a second code script corresponding to the first update; and updating first code script with the second code script.
16. The method of any one of the preceding embodiments, wherein processing the first action graph with the third autonomous model to generate the first validated action graph further comprises: generating a sandbox session for the first action graph; retrieving user profile data from a user profile for a user; retrieving state characteristics from one or more servers; populating the sandbox session with the user profile data and the state characteristics; and testing the first action graph in the sandbox session to determine whether the first action graph results in a requested final state.
17. The method of any one of the preceding embodiments, wherein the first action graph comprises a plurality of nodes and a plurality of edges from the initial state and the requested final state, and wherein generating the first action graph comprises: determining a plurality of pathways through the plurality of nodes using the plurality of edges, wherein each of the plurality of pathways comprises a respective route from the initial state and the requested final state; determining, based on the first user query, first criterion; comparing the first criterion to a first route, wherein the first route corresponds to a first pathway of the plurality of pathways; and selecting the first pathway from the plurality of pathways based on comparing the first criterion to the first route.
18. The method of any one of the preceding embodiments, wherein the first action graph comprises a plurality of nodes and a plurality of edges from the initial state and the requested final state, and wherein generating the first action graph comprises: determining a first pathway through the plurality of nodes using the plurality of edges; determining a second pathway through the plurality of nodes using the plurality of edges; determining a comparison criterion based on the first user query; and comparing the first pathway to the second pathway based on the comparison criteria.
19. The method of any one of the preceding embodiments, wherein the first action graph comprises a plurality of nodes and a plurality of edges from the initial state and the requested final state, and wherein generating the first action graph comprises: determining pairs of the plurality of nodes to connect using the plurality of edges; and determining weights for the pairs based on the state characteristics.
20. The method of any one of the preceding embodiments, wherein the first action graph comprises a plurality of nodes and a plurality of edges from the initial state and the requested final state, and wherein generating the first action graph comprises: determining a number of the plurality of nodes based on the first user query; and determining a number of edges to connect the plurality of nodes based on the first user query.
21. The method of any one of the preceding embodiments, further comprising: initiating a first device session between a first mobile device and one or more servers comprising the multi-autonomous model architecture; determining a user corresponding to the first mobile device; and retrieving a user profile corresponding to the user.
22. The method of any one of the preceding embodiments, wherein the multi-autonomous model architecture comprises a plurality of autonomous models, and wherein processing inputs by the multi-autonomous model architecture comprises: receiving one or more outputs from one or more of the plurality of autonomous models; and autonomously inputting the one or more outputs into the one or more of the plurality of autonomous models.
23. The method of any one of the preceding embodiments, wherein generating the sandbox session for the first action graph further comprises: determining a first simulation level for an external system, wherein the first simulation level indicates a level at which dependencies to the external system is simulated; comparing the first simulation level to a threshold simulation level, wherein the threshold simulation level is based on access to external systems, databases, or services of an actual production environment; determining that the first simulation level exceeds the threshold simulation level; and determining to generate the sandbox session based on the first simulation level exceeding the threshold simulation level.
24. The method of any one of the preceding embodiments, wherein generating the sandbox session for the first action graph further comprises: determining a first resource allocation for the autonomous evaluation model, wherein the first resource allocation indicates an amount of resources allocated to the autonomous evaluation model to generate the sandbox session; comparing the first resource allocation to a threshold resource allocation, wherein the threshold resource allocation is based on resources allocated to an actual production environment; determining that the first resource allocation exceeds the threshold resource allocation; and determining to generate the sandbox session based on the first resource allocation exceeding the threshold resource allocation.
25. The method of any one of the preceding embodiments, wherein generating the sandbox session for the first action graph further comprises: determining a first performance metric for the autonomous evaluation model, wherein the first performance metric indicates a performance of the autonomous evaluation model in the sandbox session; comparing the first performance metric to a threshold performance metric, wherein the threshold performance metric corresponds to a performance of an actual production environment; determining that the first performance metric exceeds the threshold performance metric; and determining to generate the sandbox session based on the first performance metric exceeding the threshold performance metric.
26. The method of any one of the preceding embodiments, wherein generating the sandbox session for the first action graph further comprises: detecting whether a first database is available to the sandbox session; and determining to generate the sandbox session based on the first database being available.
27. The method of any one of the preceding embodiments, wherein testing the first action graph in the sandbox session to determine whether the first action graph results in the requested final state further comprises: determining an initial final state based on the first action graph; comparing the initial final state to the requested final state; and generating the first validated action graph based on comparing the initial final state to the requested final state.
28. The method of any one of the preceding embodiments, wherein generating the first response to the first user query based on the first validated action graph further comprises: generating with the autonomous planner model the first validated action graph using the second code script; and processing the first validated action graph with the autonomous evaluation model.
29. The method of any one of the preceding embodiments, wherein determining the first update to the first action graph required to generate the first validated action graph further comprises: determining an initial final state based on the first action graph; comparing the initial final state to the requested final state; and generating the first validated action graph based on comparing the initial final state to the requested final state.
30. The method of any one of the preceding embodiments, wherein determining the first update to the first action graph required to generate the first validated action graph further comprises: determining an initial final state based on the first action graph; determining a difference between the initial final state and the requested final state; and determining an action graph characteristic corresponding to the difference to determine the first update.
31. The method of any one of the preceding embodiments, wherein processing the first update using the large language model to generate the second code script corresponding to the first update further comprises: determining an action graph characteristic corresponding to the first update; and inputting the action graph characteristic into the large language model to generate code script implementing the action graph characteristic.
32. The method of any one of the preceding embodiments, wherein updating the first code script with the second code script further comprises: determining a location in the first code script for inserting the second code script; and inserting the second code script at the location.
33. One or more non-transitory, computer-readable mediums storing instructions that, when executed by a data processing apparatus, cause the data processing apparatus to perform operations comprising those of any of embodiments 1-32.
34. A system comprising one or more processors; and memory storing instructions that, when executed by the processors, cause the processors to effectuate operations comprising those of any of embodiments 1-32.
35. A system comprising means for performing any of embodiments 1-32.

What is claimed is:

1. A non-transitory, computer-readable medium, comprising instructions that, when executed by one or more processors, cause operations comprising:
processing a first action graph with an autonomous evaluation model to generate a first validated action graph by:
generating a sandbox session for the first action graph;
retrieving a user profile for a user;
populating the sandbox session with user profile data from the user profile; and
testing the first action graph in the sandbox session to determine whether the first action graph results in a requested final state; and
generating a first response to the first user query based on the first validated action graph.

2. A method for validating action graphs using multi-autonomous model architectures across computer networks, the method comprising:
receiving, at a user interface, a first user query from a first user, wherein the first user query indicates an initial state and a requested final state;
in response to the first user query, generating with an autonomous planner model, of a multi-autonomous model architecture, a first action graph, wherein the first action graph comprises a plurality of nodes and a plurality of edges from the initial state and the requested final state;
processing the first action graph with an autonomous evaluation model to generate a first validated action graph by:
generating a sandbox session for the first action graph;
retrieving a user profile for a user;
populating the sandbox session with user profile data from the user profile; and
testing the first action graph in the sandbox session to determine whether the first action graph results in the requested final state; and
generating for display, in the user interface, a first response to the first user query based on the first validated action graph.

3. The method of claim 2, wherein generating the sandbox session for the first action graph further comprises:
determining a first simulation level for an external system, wherein the first simulation level indicates a level at which dependencies to the external system is simulated;
comparing the first simulation level to a threshold simulation level, wherein the threshold simulation level is based on access to external systems, databases, or services of an actual production environment;
determining that the first simulation level exceeds the threshold simulation level; and
determining to generate the sandbox session based on the first simulation level exceeding the threshold simulation level.

4. The method of claim 2, wherein generating the sandbox session for the first action graph further comprises:
determining a first resource allocation for the autonomous evaluation model, wherein the first resource allocation indicates an amount of resources allocated to the autonomous evaluation model to generate the sandbox session;
comparing the first resource allocation to a threshold resource allocation, wherein the threshold resource allocation is based on resources allocated to an actual production environment;
determining that the first resource allocation exceeds the threshold resource allocation; and
determining to generate the sandbox session based on the first resource allocation exceeding the threshold resource allocation.

5. The method of claim 2, wherein generating the sandbox session for the first action graph further comprises:
determining a first performance metric for the autonomous evaluation model, wherein the first performance metric indicates a performance of the autonomous evaluation model in the sandbox session;
comparing the first performance metric to a threshold performance metric, wherein the threshold performance metric corresponds to a performance of an actual production environment;
determining that the first performance metric exceeds the threshold performance metric; and
determining to generate the sandbox session based on the first performance metric exceeding the threshold performance metric.

6. The method of claim 2, wherein generating the sandbox session for the first action graph further comprises:
detecting whether a first database is available to the sandbox session; and
determining to generate the sandbox session based on the first database being available.

7. The method of claim 2, wherein testing the first action graph in the sandbox session to determine whether the first action graph results in the requested final state further comprises:
determining an initial final state based on the first action graph;
comparing the initial final state to the requested final state; and
generating the first validated action graph based on comparing the initial final state to the requested final state.

8. The method of claim 2, wherein receiving the first user query further comprises processing the first user query with an understanding model to generate a first action graph objective, wherein the understanding model is trained using a first large language model to determine contextual information in order to determine action graph objective outputs for inputted user queries.

9. The method of claim 2, wherein processing the first action graph with the autonomous evaluation model to generate the first validated action graph further comprises:
determining a first update to the first action graph required to generate the first validated action graph;
processing the first update using a large language model to generate a second code script corresponding to the first update; and
updating first code script with the second code script.

10. The method of claim 2, wherein the first action graph comprises a plurality of nodes and a plurality of edges from the initial state and the requested final state, and wherein generating the first action graph comprises:
determining a plurality of pathways through the plurality of nodes using the plurality of edges, wherein each of the plurality of pathways comprises a respective route from the initial state and the requested final state;
determining, based on the first user query, first criterion;
comparing the first criterion to a first route, wherein the first route corresponds to a first pathway of the plurality of pathways; and
selecting the first pathway from the plurality of pathways based on comparing the first criterion to the first route.

11. The method of claim 2, wherein the first action graph comprises a plurality of nodes and a plurality of edges from the initial state and the requested final state, and wherein generating the first action graph comprises:
determining a first pathway through the plurality of nodes using the plurality of edges;
determining a second pathway through the plurality of nodes using the plurality of edges;
determining a comparison criterion based on the first user query; and
comparing the first pathway to the second pathway based on the comparison criterion.

12. The method of claim 2, wherein the first action graph comprises a plurality of nodes and a plurality of edges from the initial state and the requested final state, and wherein generating the first action graph comprises:
determining pairs of the plurality of nodes to connect using the plurality of edges; and
determining weights for the pairs based on state characteristics.

13. The method of claim 2, wherein the first action graph comprises a plurality of nodes and a plurality of edges from the initial state and the requested final state, and wherein generating the first action graph comprises:
determining a number of the plurality of nodes based on the first user query; and
determining a number of edges to connect the plurality of nodes based on the first user query.

14. The method of claim 2, further comprising:
initiating a first device session between a first mobile device and one or more servers comprising the multi-autonomous model architecture;
determining a user corresponding to the first mobile device; and
retrieving a user profile corresponding to the user.

15. The method of claim 2, wherein the multi-autonomous model architecture comprises a plurality of autonomous models, and wherein processing inputs by the multi-autonomous model architecture comprises:
receiving one or more outputs from one or more of the plurality of autonomous models; and
autonomously inputting the one or more outputs into the one or more of the plurality of autonomous models.

16. One or more non-transitory, computer-readable medium, comprising instructions that, when executed by one or more processors, cause operations comprising:
in response to a first user query, generating with an autonomous planner model a first action graph, wherein the first action graph comprises a plurality of nodes and a plurality of edges from an initial state and a requested final state;
processing the first action graph with an autonomous evaluation model to generate a first validated action graph by:
generating a sandbox session for the first action graph;
retrieving a user profile for a user;
populating the sandbox session with user profile data from the user profile; and
testing the first action graph in the sandbox session to determine whether the first action graph results in the requested final state; and
determining to update the first action graph based on testing the first action graph in the sandbox session.

17. The one or more non-transitory, computer-readable medium of claim 16, wherein determining to update the first action graph further comprises:
receiving test feedback based on testing the first action graph in the sandbox session; and
updating the autonomous evaluation model based on the test feedback.

18. The one or more non-transitory, computer-readable medium of claim 16, wherein generating the sandbox session for the first action graph further comprises:
determining a first resource allocation for the autonomous evaluation model, wherein the first resource allocation indicates an amount of resources allocated to the autonomous evaluation model to generate the sandbox session;
comparing the first resource allocation to a threshold resource allocation, wherein the threshold resource allocation is based on resources allocated to an actual production environment;
determining that the first resource allocation exceeds the threshold resource allocation; and
determining to generate the sandbox session based on the first resource allocation exceeding the threshold resource allocation.

19. The one or more non-transitory, computer-readable medium of claim 16, wherein generating the sandbox session for the first action graph further comprises:
determining a first performance metric for the autonomous evaluation model, wherein the first performance metric indicates a performance of the autonomous evaluation model in the sandbox session;
comparing the first performance metric to a threshold performance metric, wherein the threshold performance metric corresponds to a performance of an actual production environment;
determining that the first performance metric exceeds the threshold performance metric; and
determining to generate the sandbox session based on the first performance metric exceeding the threshold performance metric.

20. The one or more non-transitory, computer-readable medium of claim 16, wherein generating the sandbox session for the first action graph further comprises:
detecting whether a first database is available to the sandbox session; and
determining to generate the sandbox session based on the first database being available.
